(19) United States
(12) Patent Application Publication
(10) Pub. No.: US 2012/0244929 A1
(43) Pub. Date: Sep. 27, 2012

(54) SYSTEMS AND METHODS FOR PROCESSING, STORING, AND DISPLAYING MAP DATA

(75) Inventors: James Allan Oakes, Rye (GB); Henry Edward Oakes, London (GB); Matthew Young, Watford (GB); Mykolas Juraitis, Chelmsford (GB); Alexander Baev, London (GB); Oleksandr Cherednychenko, Kherson (UA); Olga Melnichuk, Cambride (GB)

(73) Assignee: Roboreus Limited

(21) Appl. No.: 13/469,791

(22) Filed: May 11, 2012

Related U.S. Application Data
(63) Continuation-in-part of application No. 12/180,163, filed on Jul. 25, 2008.
(60) Provisional application No. 61/485,118, filed on May 11, 2011.

(51) Int. Cl. A63F 9/24; G06F 17/30

(52) U.S. Cl. 463/22; 707/741; 707/E17.002

(57) ABSTRACT

Systems and methods for the processing, storing, and displaying of map data are disclosed. Embodiments of the present invention facilitate more efficient storage, processing, communication, and display of maps and map-related data in connection with modern computers and communications systems. While originally developed for a map-based game, the techniques disclosed herein also have practical applications to other technical fields including but not limited to image processing (e.g., partitioning of images much like maps for storage, communication, or display) and heat mapping (e.g., visualization of a geographical distribution of certain attributes).

### CROSS REFERENCE TO RELATED APPLICATIONS

This patent application claims priority to U.S. Provisional Patent Application No. 61/485,118, entitled “Techniques for Processing, Storing, and Displaying Map Data,” filed May 11, 2011, which is incorporated herein in its entirety.

This patent application is also a continuation-in-part of U.S. patent application Ser. No. 12/180,163, entitled “Systems and Methods for Lottery-Style Games,” filed Jul. 25, 2008, which is incorporated herein in its entirety.

### FIELD OF THE INVENTION

The present invention relates generally to mapping and the storage, processing, communication, and display of map data.

### BACKGROUND OF THE INVENTION

GeoSweep™ is a map-based prize game, as previously disclosed and also described in more detail below. According to one embodiment of the GeoSweep games, a grid is overlaid on a map to divide it into small plots of land called Geos. Players use a mapping tool based on Google Maps to navigate the grid and select Geos to rent/occupy. The prize draw randomly selects a Geo to be the winner, and a number of surrounding or nearby Geos to be the runners-up.

The successful implementation of GeoSweep and other similar map-based games is a non-trivial task. In order to establish and execute such map-based prize games in an efficient manner, a number of technological improvements upon (or adaptation of) existing map-processing techniques are desirable, including, in general,—
1. Storage of map information,
2. Map breakdown techniques (i.e., how a map is initially broken down into Geos),
3. Transfer and display of map information for users to view the Geos in their web browsers, and
4. Draw and prize calculation.

Although the specific embodiments are described within the context of GeoSweep games, it should be understood that the techniques disclosed herein also have potential uses in a number of other technical fields. For example, the map breakdown techniques allow any map—or indeed any image—to be efficiently partitioned into heterogeneous rectangles (of which squares are simply a special case), each of which can store or show a number of attributes. Exemplary uses may include work allocation algorithms for division or allocation of geographical areas (e.g., defining and allocating sales territories), heat mapping (e.g., for population density visualizations), and image processing applications (e.g., dividing an image into different sized areas for parallel processing).

### SUMMARY OF THE INVENTION

Systems and methods for the processing, storing, and displaying of map data are disclosed.

One technical effect of the present invention is that its embodiments facilitate more efficient storage, processing, communication, and display of maps and map-related data in connection with modern computers and communications systems. Another technical effect of the present invention resides in the specialized computer devices that may be configured and deployed to carry out the map processing, storage, communication, and display techniques disclosed herein. Yet another technical effect of the present invention lies in the practical applications of the various techniques not just to map-based games but to other technical fields including but not limited to image processing (e.g., partitioning of images much like maps for storage, communication, or display) and heat mapping (e.g., visualization of a geographical distribution of certain attributes).

The present invention will now be described in more detail with reference to exemplary embodiments thereof as shown in the accompanying drawings. While the present invention is described below with reference to exemplary embodiments, it should be understood that the present invention is not limited thereto. Those of ordinary skill in the art having access to the teachings herein will recognize additional implementations, modifications, and embodiments, as well as other fields of use, which are within the scope of the present invention as described herein, and with respect to which the present invention may be of significant utility.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be exemplary only.

FIG. 1 is a flow chart illustrating an exemplary method of facilitating lottery-style games in accordance with one embodiment of the present invention.

FIG. 2 illustrates the flow of tokens from the perspective of a lottery game operator in accordance with one embodiment of the present invention.

FIG. 3 illustrates the flow of tokens from the perspective of a player in a lottery game in accordance with one embodiment of the present invention.

FIG. 4 is a block diagram illustrating an exemplary system for facilitating lottery-style games in accordance with one embodiment of the present invention.

FIG. 5 is a block diagram illustrating exemplary software and data-storage modules for facilitating lottery-style games in accordance with one embodiment of the present invention.

FIG. 6 shows a grid map for an exemplary GeoSweep game in accordance with one embodiment of the present invention.

FIGS. 7A-B illustrate an exemplary payout structure in an exemplary GeoSweep game in accordance with one embodiment of the present invention.

FIG. 8 illustrates an alternative payout structure in an exemplary GeoSweep game in accordance with one embodiment of the present invention.

FIG. 9 illustrates another alternative payout structure in an exemplary GeoSweep game in accordance with one embodiment of the present invention.

FIG. 10 illustrates an alternative method of establishing a grid or land boundaries in an exemplary GeoSweep game in accordance with one embodiment of the present invention.

FIG. 11 illustrates another alternative method of establishing a grid or land boundaries in an exemplary GeoSweep game in accordance with one embodiment of the present invention.

FIG. 12 shows an exemplary UK map overlaid with GeoBlocks and Geos in accordance with one embodiment of the present invention.

FIG. 13 shows exemplary GeoBlocks and Geos of various sizes in accordance with one embodiment of the present invention.

FIG. 14 shows an exemplary UK map at the beginning of a map-breakdown procedure in accordance with one embodiment of the present invention.

FIGS. 15-17 illustrate examples of procedures for modifying GeoBlocks at or near points of interest in accordance with one embodiment of the present invention.

FIG. 18 shows an example of un-optimized GeoBlocks in accordance with one embodiment of the present invention.

FIG. 19 shows an example of optimized GeoBlocks in accordance with one embodiment of the present invention.

FIG. 20 shows an exemplary image of a section of map once the generation and optimization are successfully finished in accordance with one embodiment of the present invention.

FIG. 21 is an exemplary diagram illustrating the expansion of a Prize Footprint area in accordance with one embodiment of the present invention.

### DESCRIPTION OF THE INVENTION

### Fractional and/or Map-Based Lottery Games

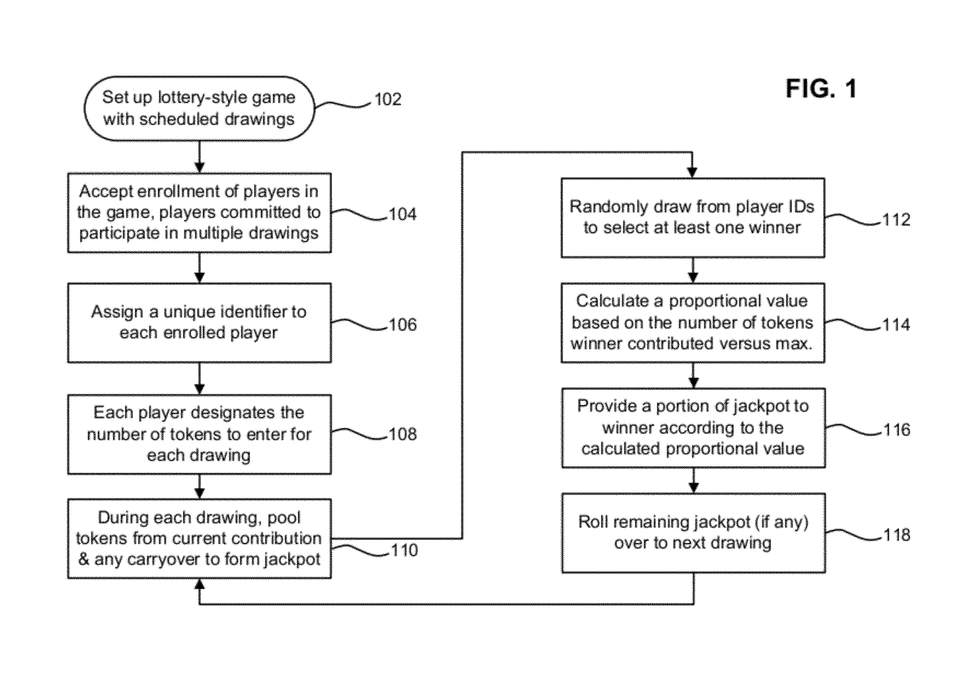

Referring to FIG. 1, there is shown a flow chart illustrating an exemplary method of facilitating lottery-style games in accordance with one embodiment of the present invention.

In step 102, a lottery game may be set up. The lottery game may be an ongoing one that is scheduled to have a plurality of lottery drawings over a period of time. For example, the lottery drawings may occur on a periodic basis, such as once every hour, one or more times every calendar day or every business day, one or more times every week, or a predetermined number of times per month or year. As the lottery game is set up, a set of rules, terms and conditions may be published or otherwise communicated to potential participants. The rules may define how the lottery game is operated and how the lottery drawings are conducted, as well as calculation and payout of prizes, as will be described in more detail below. The terms and conditions may specify rights and obligations of persons participating in the lottery game and lottery drawings.

In preferred embodiments of the present invention, the lottery game is established online and accessible via an Internet website. The lottery game may also be implemented in connection with one or more social networking websites, such as Facebook™ MySpace™, or LinkedIn™. Alternatively, the lottery game may also be implemented in connection with one or more virtual reality games such as Second Life™ or other multi-player video games. The lottery game may be either an add-on or an integrated part of an associated website, wherein participation in the lottery game may enhance a player's experience at the associated website or vice versa. According to some embodiments, the lottery game and lottery drawings may be implemented at least partially offline, without requiring every participant to have computer or Internet access.

In step 104, players may be enrolled in the lottery game. Each person wishing to join the lottery game may be required to make a commitment to participate in a number of the scheduled lottery drawings. In one exemplary enrollment process, a player may (a) manifest consent to the set of rules, terms and conditions established in the lottery game and (b) deposit or pledge some amount of money or other things of value to be contributed to the game. The amount of initial deposit or pledge may depend on such factors as how many lottery drawings the player is obligated to participate in, how much wager the player is to enter for each drawing, the player's credit ratings, and so on.

Enrollment of players may be taken via a web interface, by mail, or through other communication means. When the lottery game is implemented in connection with a social networking website or other membership sites, enrollment in the lottery game may be simplified with the existing membership information. Alternatively, the lottery game operator, administrator, or personnel may receive and approve enrollment in person. In some instances, new players may join through referrals and/or gift membership.

In step 106, each enrolled player may be assigned one or more unique identifiers. Each player identifier (or player ID) may be a text string, a serial number, or other symbols. According to one embodiment, each player ID may be associated with a “Lucky Star” of the player's choice. According to some embodiments, each player ID may comprise a machine readable portion (e.g., an alphanumeric string) and a human recognizable portion (e.g., a logo, icon or catch phrase). For a player, one of the assigned player IDs may be used as a username for logging into an Internet-based lottery game. Or, the player may choose a different username to log in but is still able to manage multiple player IDs assigned to that player. The assigned player IDs may be imprinted or encoded on a membership card.

In the drawings or games described herein, each registered player can participate with one or multiple player IDs. When participating with multiple player IDs, the rules regarding each of the multiple player IDs are the same as if each player ID is owned and controlled by a single player. For ease of illustration, it is assumed in the following description that each player participates with a single player ID.

In step 108, each player may designate the number of tokens to enter for each drawing. That is, with respect to each lottery drawing the player is committed to participate in, the player may specify a wager amount that is typically measured in the number of tokens. As used herein, a “token” may be or represent any physical or virtual thing of value that can be counted or quantified. For example, a token may be or represent one or more units of cash or credit. Or, a token may be or represent one or more points that are exchangeable for things of value. According to one embodiment of the present invention, one token may be the equivalent of one cent ( 1/100 of a dollar). According to another embodiment, one token may be or represent one value point that may be used to exchange for music downloads, cell phone ring-tones, or for other online or in-store purchases. According to yet another embodiment, one token may represent one unit of a game score in an online video game or a virtual society. According to still another embodiment, one token may be or can be exchanged for one or more units of mobile telephone airtime or long-distance telephone minutes.

The players may purchase tokens with their initial deposits. They may set up electronic fund transfers and/or automatic credit card payments to refill their accounts with tokens. A player's account may be replenished automatically as soon as its balance falls below a preset lower limit. Apart from winning or purchasing refills, the players may alternatively or additionally obtain tokens through bartering or by engaging in certain activities. For example, a player may exchange credit card cash-back bonus points for tokens. The player may also take part in online surveys, view online advertisements, or increase activity level at social networking or blogger websites to earn tokens.

The number of tokens designated for each lottery drawing should typically fall within a certain range. For lottery drawings that take place on a daily basis, for example, there may be a daily minimum and a daily maximum for the number of tokens a player can contribute per player ID. According to one embodiment of the present invention, the daily minimum may be one token (e.g., one cent or one pence) and the daily maximum may be one hundred tokens (e.g., one dollar or one pound). The number of tokens that a player designates for each drawing may be any of a fixed value between and including the daily minimum and the daily maximum. Alternatively, the player may configure the daily wager to be a variable amount. To have a minimal level of participation in the lottery game (thus a more predictable revenue from the game), the game system may be configured to prevent players from lowering their preset daily wager amount for any upcoming drawings.

For each lottery drawing, a jackpot prize may be formed, in step 110, from two sources: (a) tokens contributed by players who participate in that drawing, and (b) tokens carried over from one or more previous drawings, if available. Tokens from the two sources may be pooled together into one jackpot. The jackpot (or a portion thereof) may account for a maximum payable amount for a winner of that lottery drawing.

In step 112, a random drawing from the player IDs may be conducted to select at least one winner. Note that the word “random” does not require randomness in the most rigorous statistical sense as such randomness is difficult to achieve. Instead, the word “random” implies a fair drawing process that does not appear to favor any one player more than any other player. The random (fair) drawing from the player IDs may be achieved in a number of computational methods as are well known in the gaming industry. According to some embodiments of the present invention, a single winner may be selected for each lottery drawing. According to some alternative embodiments, two or more winners may be selected for each drawing and they may share a prize fund on equal footings or according to an award hierarchy.

Then, in step 114, a proportional value may be calculated based on the number of tokens the selected winner(s) contributed versus the maximum number allowed per player ID. Assuming there is only one selected winner, the proportional value (F) may be calculated by dividing the number of tokens the winner contributed (n) with the maximum number a player is allowed to contribute (M) to that individual lottery drawing. That is

Error! Objects Cannot be Created from Editing Field Codes.

If there are multiple winners, the proportional value may be calculated for each winner. For example, if a selected winner contributed the maximum number of tokens for that lottery drawing, the proportional value for that winner would be one (1) or 100%. If the selected winner contributed half of the maximum number of tokens allowed, the proportional value would be ½ or 50%. The proportional value calculated in this step may be represented with either a fraction or a percentage.

In step 116, a fraction of the jackpot (or maximum payable prize) may be provided to the selected winner(s) according to the proportional value calculated in step 114 above. That is, whatever the full prize amount (P) a winner might have been entitled to had he or she contributed the maximum number of tokens (M), the actual payout amount (p) may be reduced to a fraction of that full prize amount in proportion to the number of tokens contributed (n). That is

Error! Objects Cannot be Created from Editing Field Codes.

The same proportional payout rule applies to single-winner as well as multiple-winner scenarios. The actual payout may be made by depositing tokens into a winner's account in the game system. Alternatively, the winner may receive the prize in the form of cash, points, airtime or long-distance minutes, other things of value, or a combination thereof. Other payout arrangements are also possible.

In step 118, the remainder of the jackpot prize may be rolled over to a next drawing. Unless one or more selected winners happen to have wagered the maximum number of tokens and therefore won the entire jackpot, there would always be some remaining jackpot to add to the jackpot of the next drawing. In addition, the enrollment rule ensures continuous participation in the ongoing lottery drawings. As a result, the jackpot may quickly snowball into a large amount, further increasing players' interest in the game.

For business advantages, it may be preferable to set the maximum number of tokens that each player ID can contribute to each drawing at a relatively low value. For example, if the daily maximum that can be entered for a daily drawing is one dollar, a player can contribute as little as one cent but never more than one dollar. The player will not feel any significant financial impact or burden to continue playing the lottery game for many drawing days. By wagering the equivalent of pocket change on a daily basis, the player may still enjoy a decent chance of winning a substantial amount of money.

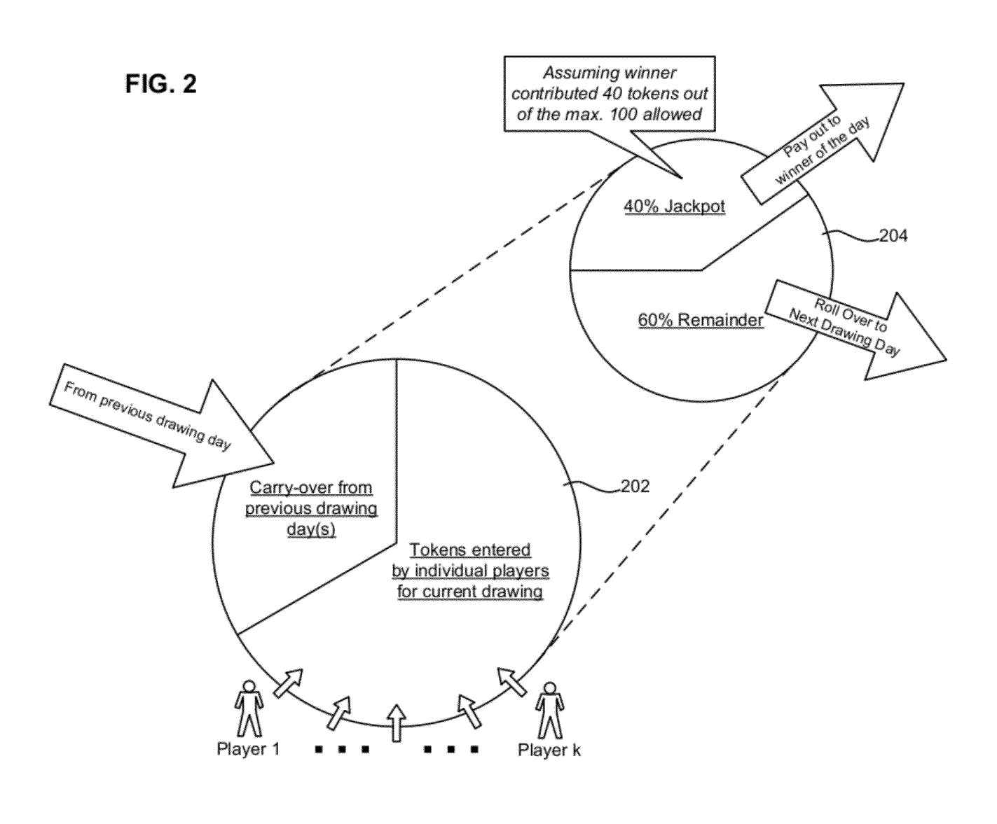

FIG. 2 illustrates the flow of tokens from the perspective of a lottery game operator in accordance with one embodiment of the present invention. For ease of illustration, it will be assumed that lottery drawings in the lottery game occur on a daily basis. On each drawing day, a pie chart 202 represents a jackpot prize and sources thereof, whereas a pie chart 204 represents the same jackpot prize (but shown separately for clarity) and disbursement therefrom. The pie chart 202 indicates that a first portion of the present drawing day's jackpot include tokens carried over from one or more previous drawing days. The pie chart 202 also indicates that second portion of the jackpot include tokens contributed by individual players for the current drawing. The pie chart 204 indicates that at least a fraction of the jackpot prize may be paid out to a winner of the day. Assuming there is a single winner and that player contributed 40 tokens out of the maximum 100 allowed, 40% of the jackpot prize may be paid out to the winner. In that case, the remaining 60% of the jackpot may be rolled over to a next drawing day.

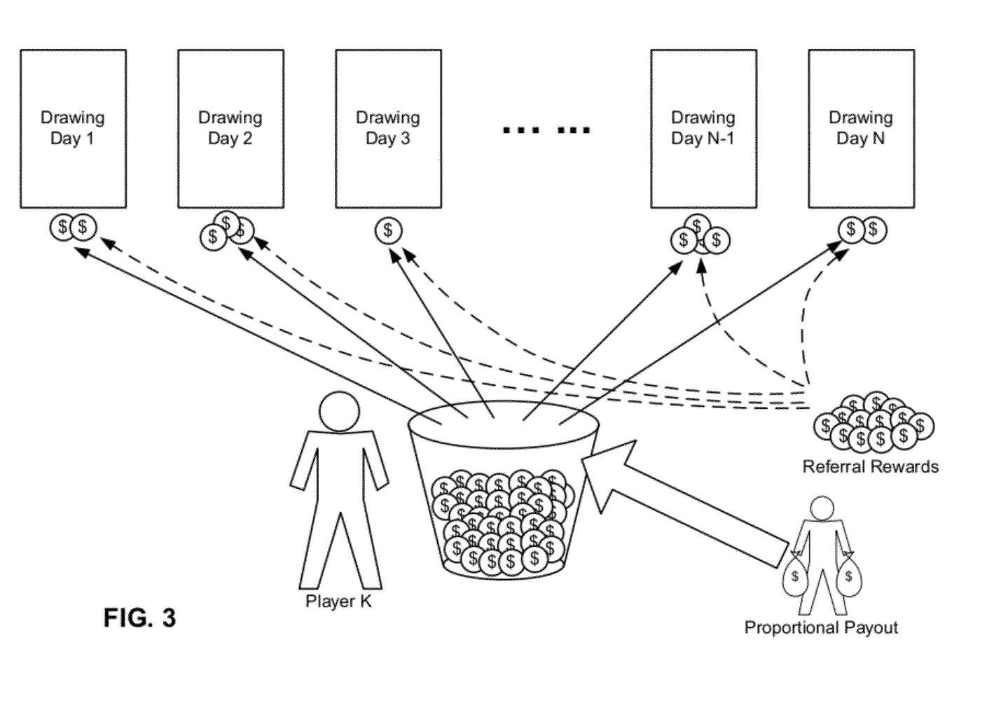

FIG. 3 illustrates the flow of tokens from the perspective of a player in a lottery game in accordance with one embodiment of the present invention. The exemplary player, Player K, may be committed to participate in N lottery drawings occurring on N consecutive days, wherein N is an integer greater than one. The bucket of dollar-sign tokens represents an account balance for Player K. Player K may have started with a “full bucket” of tokens that were purchased upon enrollment. As described earlier, Player K may designate one or more tokens to be contributed to each daily drawing. The number of tokens designated may be constant or may vary day-to-day. As drawing days go by, unless Player K wins in one or more lottery drawings, Player K's account may be slowly depleted and may have to be replenished. If Player K happens to be picked as a winner in one of the drawings, the proportional payout from that drawing may also replenish Player K's account to some extent.

According to one embodiment of the present invention, Player K may also enjoy another source of tokens—referral rewards. In order to encourage Player K to refer additional players to join the lottery game, Player K may be awarded a number of tokens for each new player brought into the game. The referral rewards may be simply deposited into Player K's account. Alternatively, the referral rewards may be automatically entered into daily drawings on behalf of Player K and in addition to Player K's own contribution to the daily drawings. For example, for each new player that Player K received, one or more tokens may be added to Player K's daily wager amount. These additional tokens may be awarded to Player K as long as the newly referred player remains an active participant in the lottery drawings. Furthermore, the amount of referral rewards may be linked to activity level of the new player referred.

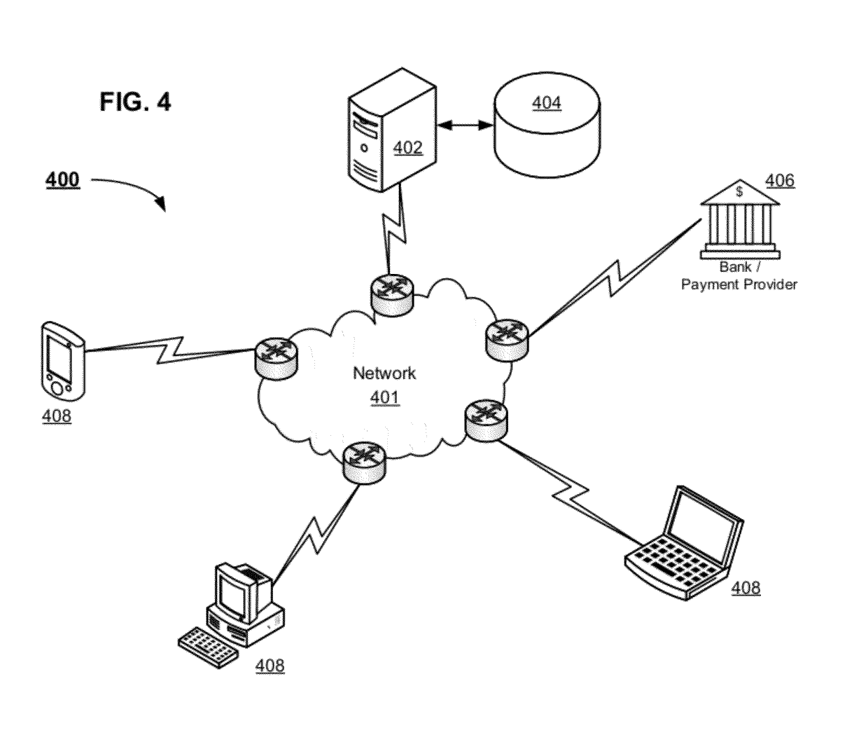

FIG. 4 is a block diagram illustrating an exemplary system 400 for facilitating lottery-style games in accordance with one embodiment of the present invention.

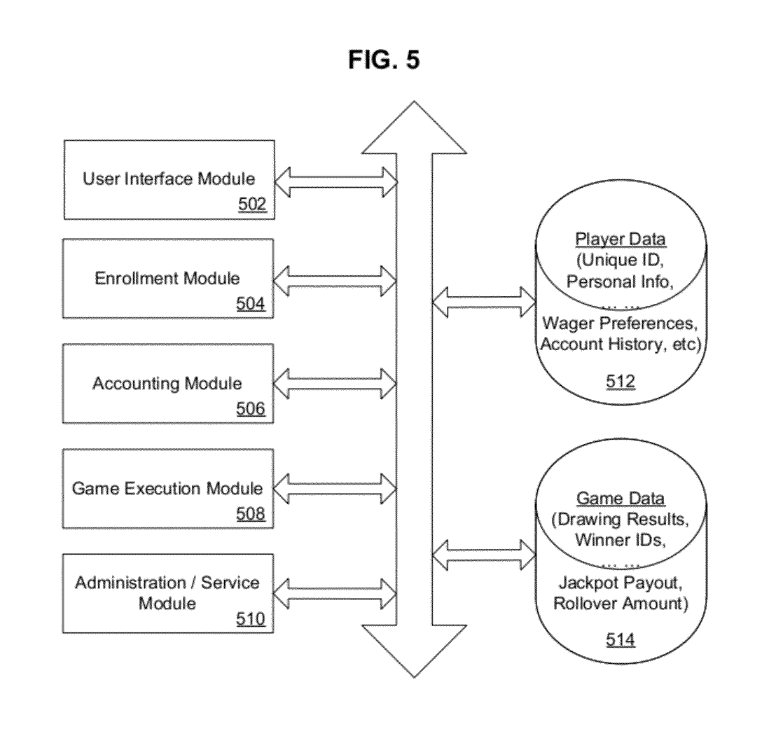

The system 400 may be or include a computer system. This embodiment of the present invention may be described in the general context of computer-executable instructions, such as program modules, being executed by a computer. Generally, program modules include routines, programs, objects, components, data structures, etc. that perform particular tasks or implement particular abstract data types. A series of programmable instructions may be stored in a computer-readable medium performing the lottery-style gaming functions disclosed herein and to achieve technical effects in accordance with the disclosure. More exemplary software and data-storage modules will be described below in connection with FIG. 5.

The lottery-style games described herein may be entered into and/or played at one or more game terminals or kiosks on or near the premises of a casino, a department store, a shopping mall, or other suitable commercial sites. For example, potential participants in a lottery-style game might be limited by laws which prohibit online wagering with payment cards. It may be beneficial for those participants to visit, or have someone else visit on their behalf, a commercial outlet with above-mentioned game terminals or kiosks where they can lawfully register and/or play the lottery-style games. Once a player has registered and funded his/her membership, he/she may continue monitoring the daily progress of the game via Internet or other communication means. As needed, the player may occasionally re-visit the game terminals or kiosks to re-fill accounts associated with his/her player IDs.

Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system of platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The system 400 may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

More specifically, the system 400 may comprise at least one gaming server 402 coupled to one or more databases 404 and/or other data sources. The gaming server 402 may run a plurality of software modules to facilitate lottery-style games in accordance with embodiments of the present invention. The database(s) 404 may hold data records related to players and lottery drawings. One additional data source may be a bank or payment provider (406) that performs payment and/or credit services for the lottery game operator and players. Via a network 401, the players may communicate, locally or remotely, with the gaming server 402 in order to enroll in the lottery game, participate in drawings, and manage player accounts. The players may employ a variety of computing devices 408 such as personal computers, mobile computers, personal digital assistants or handheld devices for communication with the gaming server 402.

FIG. 5 is a block diagram illustrating exemplary software and data-storage modules for facilitating lottery-style games in accordance with one embodiment of the present invention. The exemplary modules may include a user interface module 502, an enrollment module 504, an accounting module 506, a game execution module 508, an administration/service module 510, a player data module 512, and a game data module 514. These software modules may be programmed or configured to communicate with one another or with the data-storage modules.

The user interface module 502 may provide computer and/or Internet access for players and game operators/administrators to communicate with the other software modules. The enrollment module 504 may perform functions related to registering new players, such as verifying player information, assigning player IDs, and creating player records. The accounting module 506 may be responsible for managing player accounts and handling debit and credit transactions against the player accounts, including daily wagering and winner payouts. The game execution modules may perform functions such as scheduling and conducting lottery drawings, generating and publishing drawing results, and calculating proportional values and payout amounts. The administration/service module 510 may facilitate administrative and customer service tasks to be performed by an operator or personnel of the lottery game system.

The player data module 512 may contain and manage data records related to each player, such as player ID, personal information, wager preferences, account history, and so on. The game data module 514 may contain and manage data records related to the lottery drawings, such as drawing results, winner IDs, jackpot payouts, and roller amounts.

As variations of and/or improvement upon the above-described lottery-style games, other embodiments of the present invention may offer similar, membership-based games in connection with virtual and/or real maps. This type of lottery-style games may be referred to and are intended to be marketed or promoted as GeoSweep™ games. In a typical GeoSweep™ game, a grid pattern may be overlaid over a map dividing a land into grid units. A player may enroll in the game by taking virtual land ownership of one or more grid units and becoming committed to participate in a series of scheduled lottery drawings. The player may participate in a drawing by contributing tokens of value on behalf of at least one grid unit the player owns. During any of those drawings, if a grid unit owned by the player is selected as a (first-prize) winner, that player may receive a full or proportional prize amount. Additional winners in that drawing may be selected to win lesser amounts than the first-prize winner. Those additional winners are selected and their payout amounts are determined based on map positions of the additional winners with respect to the first-prize winner.

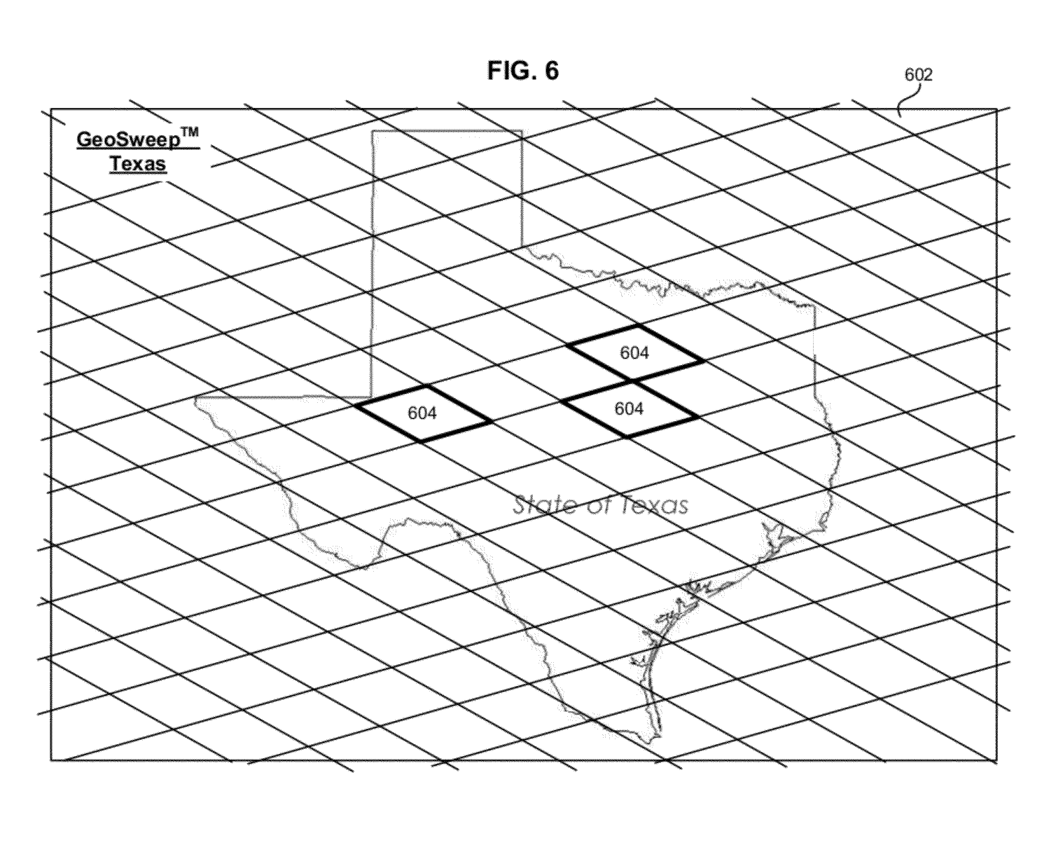

FIG. 6 shows a grid map for an exemplary GeoSweep game in accordance with one embodiment of the present invention. The game may be referred to as “GeoSweep Texas,” wherein a map of the State of Texas is overlaid with a grid 602. Each grid unit 604 may be a rectangle or a square of the same or similar size. In general, a grid unit can take any other shape, such as triangle, hexagon (honeycomb) or other polygon. In some GeoSweep games, the grid units can have different shapes and/or sizes without substantially affecting the operation of the games. As a result, the grid 602 may divide up land of Texas into a plurality of small parcels with well defined boundaries. Each of the parcels (or grid units 604) may be uniquely identified.

To participate in the GeoSweep Texas game, a player may be required to register to become a member. During registration, the player may pick one or more of available parcels to become a virtual owner thereof. There may or may not be an upfront cost for “owning” a parcel. Both sole and shared ownership may be possible for a parcel. In some instances, it might be beneficial to hold an auction among multiple interested players to determine which player gets a popular parcel. In addition, the player may make a commitment to participate in a plurality of scheduled lottery-style drawings involving the one or more parcels. The plurality of scheduled lottery-style drawings may take place periodically, such as once or more times a day, every other day or every few days, or a number of times per week or month. In each drawing, each participating parcel may be required to contribute a predetermined number of tokens to a prize pool or jackpot. The predetermined number may be a fixed one set by the game operator or administrator, or, alternatively, a variable one to be designated by each individual owner of the participating parcels. In any case, upon registration, each player may be required to fund his or her commitment to participate in drawings by depositing or pledging some amount of money.

At each drawing, one or more parcels or grid units 604 may be randomly selected as sole winner(s) or first-prize winner(s). For ease of explanation, it is assumed hereinafter that each drawing selects a single grid unit as a sole winner or a first-prize winner. In the case of a sole winner, an entire amount of jackpot or a calculated fraction thereof may be awarded to the owner of that winning grid unit. More typically, in addition to a first-prize winner, one or more winners of lesser amounts may be determined based on their relative map positions with respect to the first-prize winner. According to some embodiments, the drawing may be limited to parcels that are already owned or claimed by participating players, thereby ensuring at least one player will be entitled to a prize as described in more detail below. According to some embodiments of the present invention, the parcels or grid units may each have the same chance of being drawn as a first-prize winner. According to other embodiments, the parcels or grid units may have varying chances of being picked as a winner. For example, when a parcel costs more to own than others, it might enjoy a better chance of winning.

The prizes in each drawing may comprise tokens of value which have been contributed to that drawing by participating parcels. The prizes may also comprise rollover prizes from a previous drawing. In addition or as an alternative, the prizes may comprise other things of value. For example, a marketing partnership may be formed between the game operator and other business entities. In return for promotional or advertising activities on the GeoSweep game platform, the business partners may contribute products and services to be awarded as prizes. If justified by the cost or return on investment, an actual piece of land or other real property may be awarded to a first-prize winner or a sole jackpot winner.

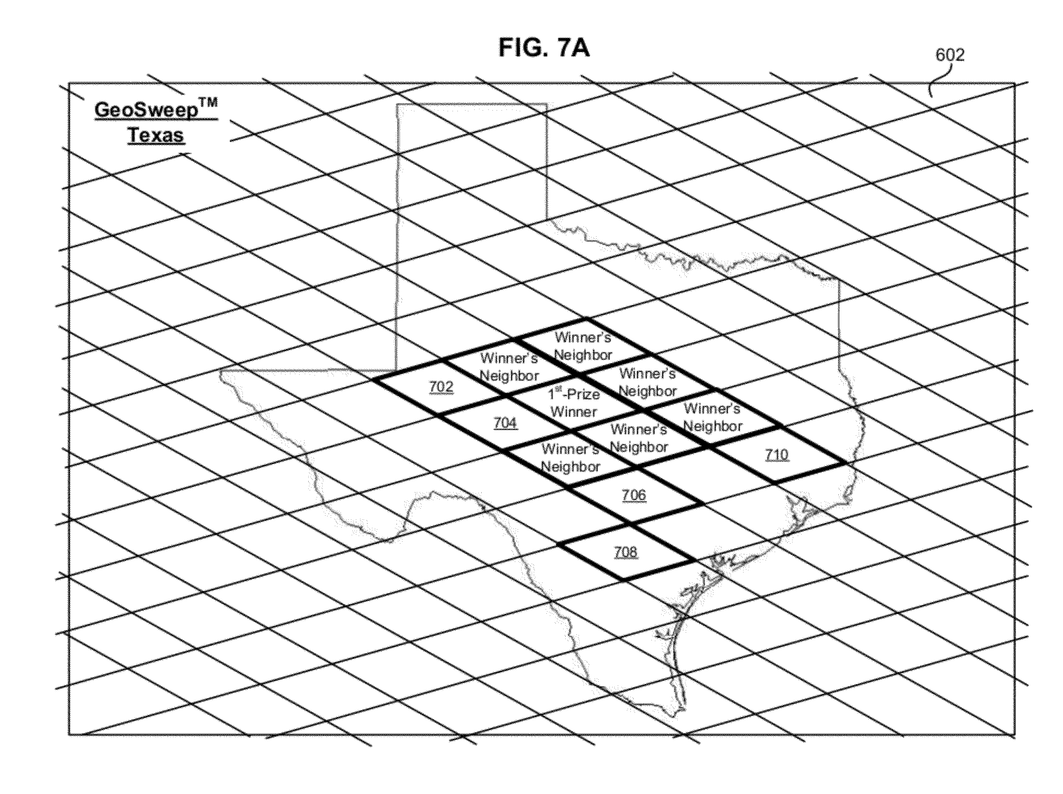

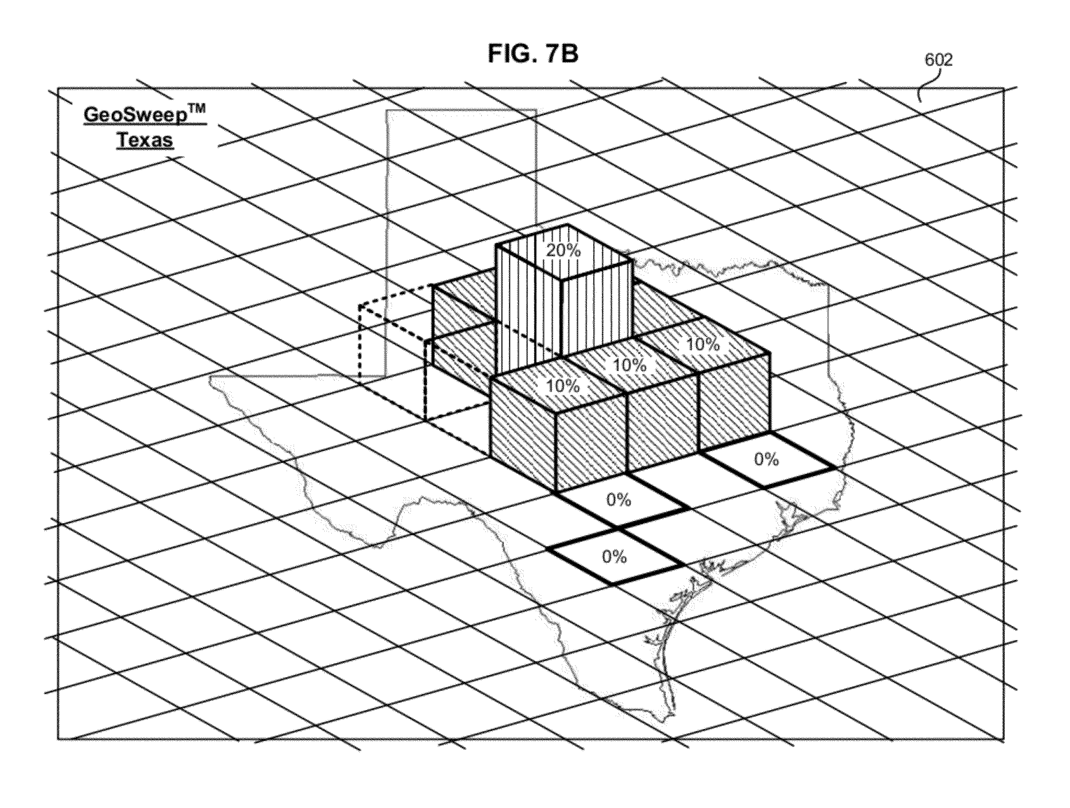

FIGS. 7A-B illustrate an exemplary payout structure for the GeoSweep Texas game described above.

FIG. 7A shows one grid unit that has been selected as a first-prize winner. That first-prize winning grid unit has eight neighboring grid units among which six are owned by participating players while the other two (702 and 704) are not owned by any player. Grid units 706, 708 and 710, which are owned by some players, do not share any common boundary with the grid unit selected for the first prize.

Referring to FIG. 7B, the first-prize winning grid unit may be allocated a prize amount that equals 20% of the jackpot available for that drawing. The eight grid units which happen to be the winner's neighbors may each be allocated 10% of the jackpot. Thus, were all eight grid units of the winner's neighbors owned by participating players, the entire jackpot would have been disbursed among owners of the nine parcels (i.e., 1×20%+8×10%=100%). However, since two of the winner's neighbors (702 and 704) are not occupied or owned by any player, the two 10% shares (i.e., 20% of jackpot) that would have been allocated to owners of grid units 702 and 704 may now be deemed not won by anyone and can be rolled over to the next drawing. The grid units 706, 708 and 710, which are further away from the first-prize winning grid unit than the winner's neighbors, do not win anything in this round of drawing.

According to one embodiment of the present invention, the GeoSweep game may include mechanisms to encourage player referrals. For example, in a GeoSweep Texas game where Texas is divided into 20 million parcels, a player owning 20 parcels may be gifted an additional unit for every new player that he or she refers. Each parcel has an equal chance of winning the first prize. Thus, the effect of the referral reward may be somewhat different from that in a proportional lottery-style game described earlier. In a lottery-style game, the referral reward has the effect of increasing the proportion of the prize that a referring player would win. Here, in a GeoSweep game, the referral reward has the effect of increasing the chance of winning.

According to another embodiment of the present invention, the GeoSweep game may also have a proportional lottery aspect to it. In that case, at or shortly after registration, a player in the GeoSweep Texas game may specify how many tokens to be entered for drawings on behalf of a parcel the player owns. The number of tokens entered for each drawing and on behalf of each parcel may be within a predetermined range, for example, between 1 and 100 inclusive. In a drawing, if a parcel is selected as a first-prize winner, then a proportional value may be calculated based on the number of tokens that have been entered on behalf of that parcel. For instance, if 100 is the maximum number of tokens that can be entered for each parcel and 45 tokens are actually entered on behalf of the first-prize winning parcel, then the proportional value is calculated to be 45% (i.e., 45/100). Next, that proportional value may be applied to whatever payout structure is applicable, such that the owner of the first-prize winning parcel will only be awarded a fraction (e.g., 45%) of the full first-prize amount. According to some embodiments, owners of the winner's neighboring parcels may be subject to the same proportional value applied to the first-prize winner. Alternatively, according to some other embodiments, the payout to a winner's neighboring parcel may be subject to a different proportional value calculated based on the number of tokens contributed on behalf of that particular parcel. Therefore, the above-described map-based payout structure may be used to determine full prize amounts for the winner's neighbors, whereupon such full prize amounts may be reduced according to the individual proportional values calculated for each of those parcels.

It should be appreciated that the above description of the GeoSweep Texas game is exemplary only. Numerous variations or modifications may be applied to that exemplary game, such as payout structure, grid geometry, and map subject.

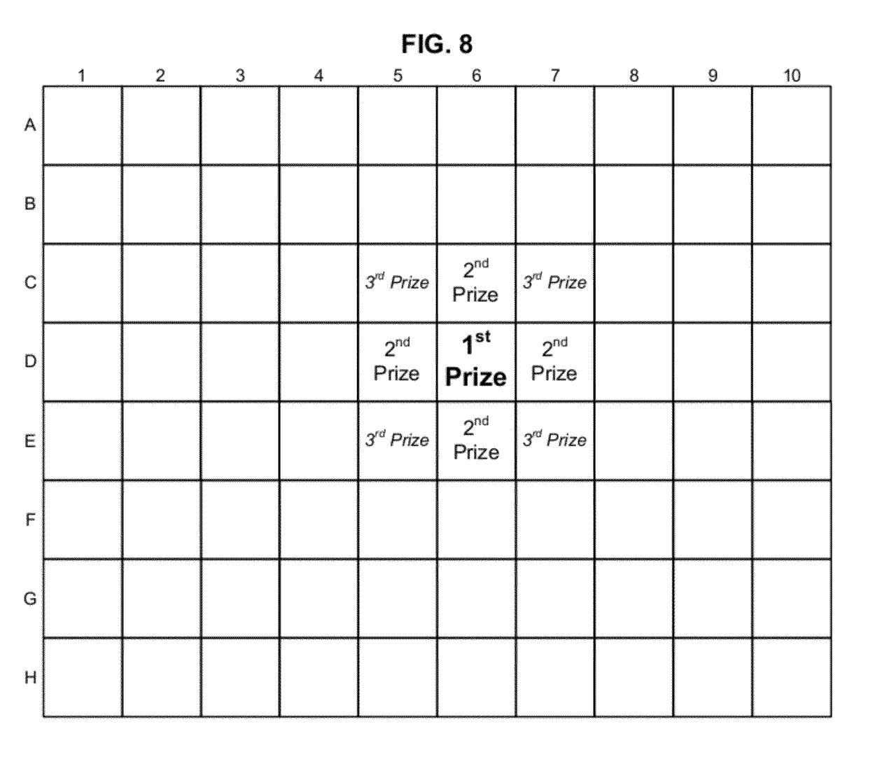

FIG. 8 illustrates an alternative payout structure in an exemplary GeoSweep™ game in accordance with one embodiment of the present invention. In a grid with rectangular or square shaped units, cell D-6 may be selected as a first-prize winner during a drawing. Then, four closest neighbors of cell D-6 (i.e., D-5, D-7, C-6, and E-6), each of which shares one side with cell D-6, may become entitled to second prizes. Four other neighbors of cell D-6 (i.e., C-5, C-7, E-5, and E-7), each of which shares only one node with cell D-6, may be entitled to third prizes. The third prizes may be of a lesser amount than the second prizes, and the second prizes of a lesser amount than the first prize. For example, the third prizes may each be 5% of a jackpot amount, the second prizes may each be 10% of the jackpot amount, and the first prize may be 40% of the jackpot amount. According to another embodiment, the first prize may be 60% of the jackpot, the second prizes may share 30% (i.e., 7.5% each), and the third prizes may share the remaining 10% (i.e., 2.5% each).

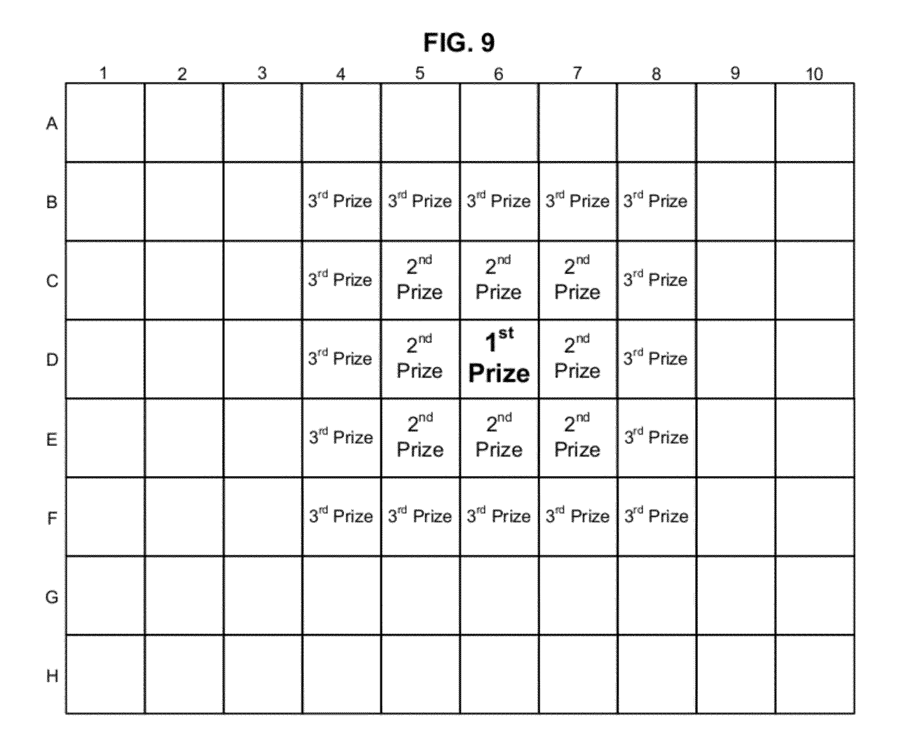

FIG. 9 illustrates another alternative payout structure in an exemplary GeoSweep game in accordance with one embodiment of the present invention. In this embodiment, cell D-6 is again selected as a single first-prize winner. The eight neighbors of cell D-6 may become winners of second prizes. Further away from cell D-6, the sixteen next closest neighbors of cell D-6 may be winners of third prizes. For example, the first prize may be 68% of a jackpot, the second prizes may share 16% of the jackpot (i.e., 2% each), and the third prizes may share 16% of the jackpot (i.e., 1% each). According to other embodiments, additional “rings” of neighbors may be included as winners of even lesser prizes.

According to some embodiments of the present invention, two or more grid units may be selected as first-prize winners. A set of rules may be established to determine which other grid units qualify as second-prize winners, third-prize winners, and so on. For example, grid units which are immediate neighbors of the selected first-prize winners may win second prizes. Then, if the first-prize winning grid units are far apart from one another, there may be multiple pockets or clusters of prize winners, each pocket or cluster being centered around one first-prize winner.

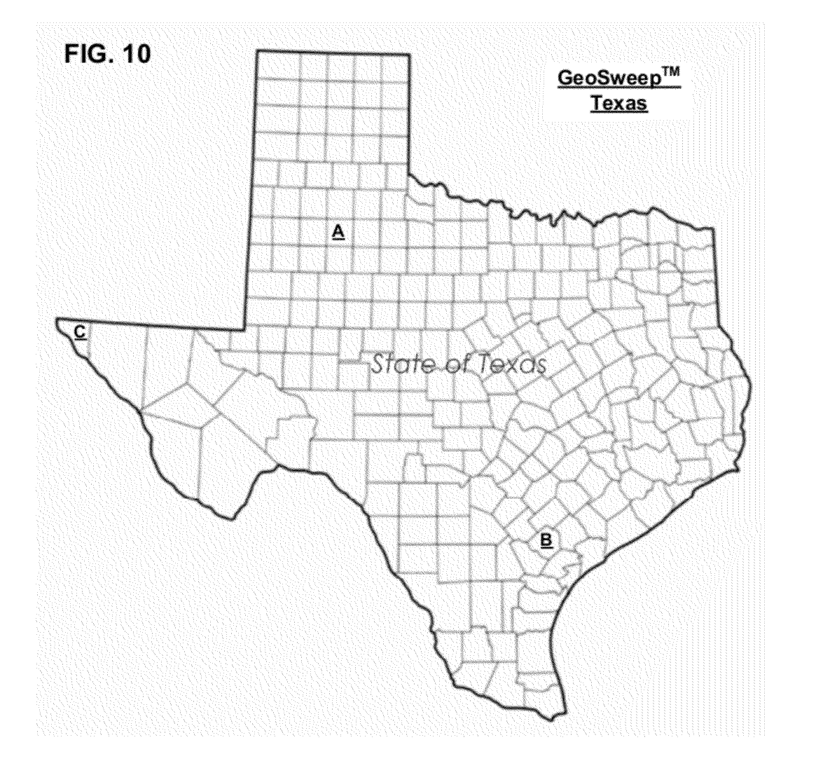

FIG. 10 illustrates an alternative method of establishing a grid or land boundaries in an exemplary GeoSweep game in accordance with one embodiment of the present invention. In this version of the GeoSweep Texas game, rather than overlaying a uniform grid over the Texas map, actual boundaries among the Texas counties may help define grid units of various sizes and shapes. Alternatively, actual land boundaries may define grid units for the GeoSweep game, such that the GeoSweep grid units correspond to actual land parcels. According to one embodiment, every grid unit (e.g., county or smaller parcels) may still cost exactly the same to “own” and/or have the same chance of being selected as a winner. According to another embodiment, the grid units or counties may cost differently and/or have varying chances of winning based on size and popularity of each county or parcel. In some embodiments, game parameters associated with a parcel on the GeoSweep map may be correlated to or associated with the conditions, market value, and popularity of the corresponding piece of land in the real world.

Since the grid units are irregularly shaped and in a non-uniform grid, different grid units may have different number of neighbors. For example, County A has eight neighboring counties, County B has five, and County C has only one. Depending on which grid unit is selected as a first-prize winner, there may be at least one but up to eight immediate neighbors who may be entitled to a second prize. One solution is to designate a fixed percentage of the jackpot that each second-prize winner is entitled to. For example, if each second-prize winner takes 2% of the jackpot, then 9 neighbors of the first-prize winner will share 18% of the jackpot while 2 neighbors (if there are only two) will only take 4% of the jackpot. Alternatively, a fixed percentage of the jackpot may be shared among the second-prize winners regardless of how many second-prize winners there may be. In that case, if a first-prize winner has only one neighbor, such as the case of County C, that single neighbor will be the sole second-prize winner taking the entire amount that has been allocated to second prizes. If the first-prize winner has eight neighbors, such as the case of County A, the eight neighbors will each take ⅛ of the entire amount that has been allocated to second prizes.

Many variations of prize-sharing schemes may be implemented for GeoSweep and/or proportional lottery-style games. In one embodiment, players that were introduced to the game by an existing player may share some of their winnings with that original (referring) player. In a further embodiment, groups of players may form prize-sharing clusters or syndicates.

Although a map of the State of Texas is used above as an example, it should be appreciated that maps of other types of geographic regions (e.g., township, city, county, country, ocean, island, and continent) may also be appropriate in GeoSweep games in accordance with embodiments of the present invention. For example, there may be GeoSweep USA, GeoSweep Europe, GeoSweep London, GeoSweep Hawaii, and so forth. In fact, a GeoSweep game may be established for a tourist destination and help promote tourism by offering prizes related to that destination or portions thereof. For example, a GeoSweep Alaska game may offer free roundtrip airline tickets as or in addition to a first prize. The game may also offer free hotel accommodation in hotels that happen to be located within a winning grid unit. Since the GeoSweep games are map-based and/or location-specific, promotional opportunities and variations are almost endless, as will be appreciated by those of ordinary skill in the art of advertising and marketing.

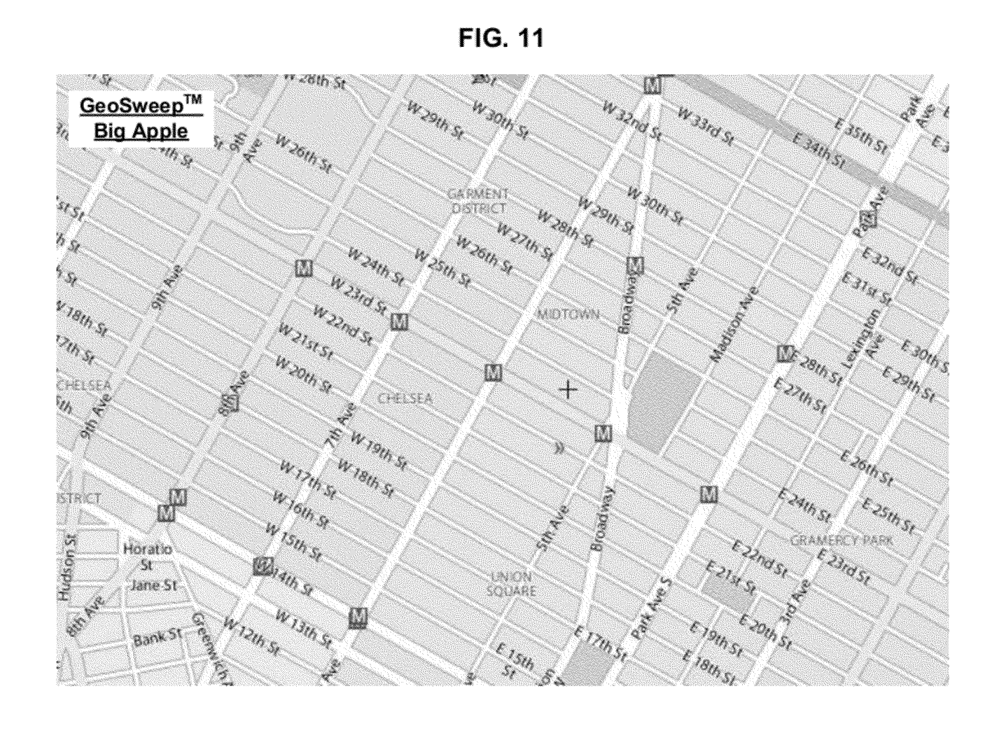

FIG. 11 illustrates part of a New York City map to be used in an exemplary game which may be referred to as “GeoSweep Big Apple.” As shown, the actual streets and avenues in mid-town Manhattan may serve to define grid units for the GeoSweep game. Local residents, business entities, and/or tourists may be encouraged to participate in this game. Each potential group of players may be offered different incentives. A local resident may be interested in virtual ownership of a street block that he or she actually lives on, and participation in the GeoSweep game may also be a social networking opportunity with other community members. A local business might be interested in sponsoring promotions and placing its name on the GeoSweep map. In fact, the GeoSweep map may be an online, interactive map with promotional and informational features. A tourist may also be interested in the game for various reasons, such as to get familiar with the area and to win travel-related prizes offered by local businesses.

### Storage of Map Information

### Geos and Map Requirements

In current implementation of GeoSweep games, Geos are square areas of land that a user may rent or select in order to participate in the prize draws in the games. The sizing and arrangement of the Geos is performed based on a number of map construction and storage techniques. Embodiments of these techniques may typically satisfy the following requirements:
Permit multiple different sizes of Geos to be used on the map—for instance smaller Geos in urban locations and points of interest and larger ones in countryside or wilderness areas;
Ensure that Geos “follow the borders” of the state/country on the game board and do not extend more than a specified amount into the sea or neighbouring states;
Ensure that each point in the state/country is covered by exactly one Geo, i.e., there are no gaps between Geos and no overlaps of Geos;
Store the map data highly efficiently—e.g., at well over 100× compression in the current UK implementation (nearly 60 million Geos of four different sizes are represented by just a couple of hundred thousand records);
Make it easy to do “All Geo” draws where each Geo, regardless of size, has the same chance of winning;
Permit extensions of and adjustments to the map without losing game board history.

### GeoBlocks

At the heart of the map storage techniques is the GeoBlock. A GeoBlock is a rectangle on the map. It is typically filled with a grid of one or more same-sized Geos. GeoBlocks are not allowed to overlap with each other. In most cases a GeoBlock will be surrounded on all sides by other GeoBlocks—and there usually should be no gaps between them. The exception to this is at the edge of the mapped country/state, i.e., along the coastline/border. It is typically not desirable to have Geos extending far out to sea (though they might extend up to, for example, 100-200 metres from the coastline to take in piers, marinas, surfing spots, and so on). Neither is it desirable for Geos to be in a different country than the main one on the map. For example, a map of the UK might also show at least parts of France, Belgium, Ireland etc, but it may not be desirable for any of the Geos in a UK game to be in those other countries. GeoBlocks may be implemented accordingly to achieve these objectives.

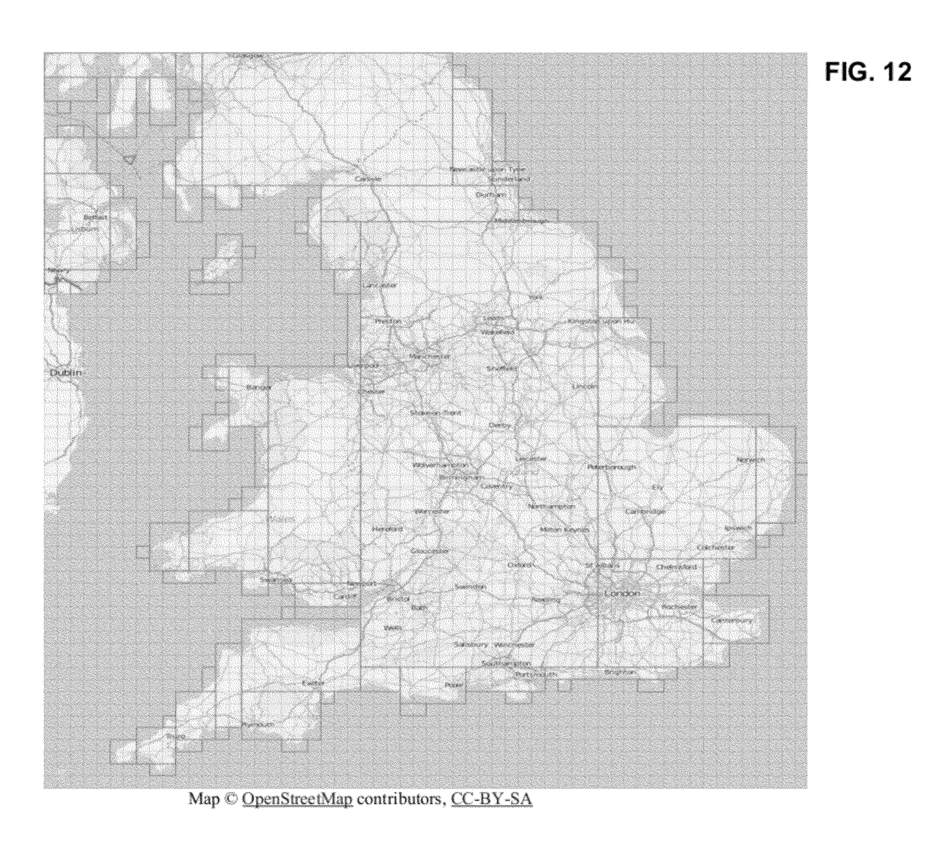

By way of illustration, FIG. 12 shows a partial map of the United Kingdom (UK) on which exemplary GeoBlocks for extremely large Geos (about 10,000 m×10,000 m) have been arranged (for illustration purposes). The squares make up the Geo grid. The rectangles with bold edges are GeoBlocks covering the land area of the country. In reality, GeoBlocks are defined algorithmically—since defining them by hand for 20 m×20 m resolution would be far too labour-intensive.

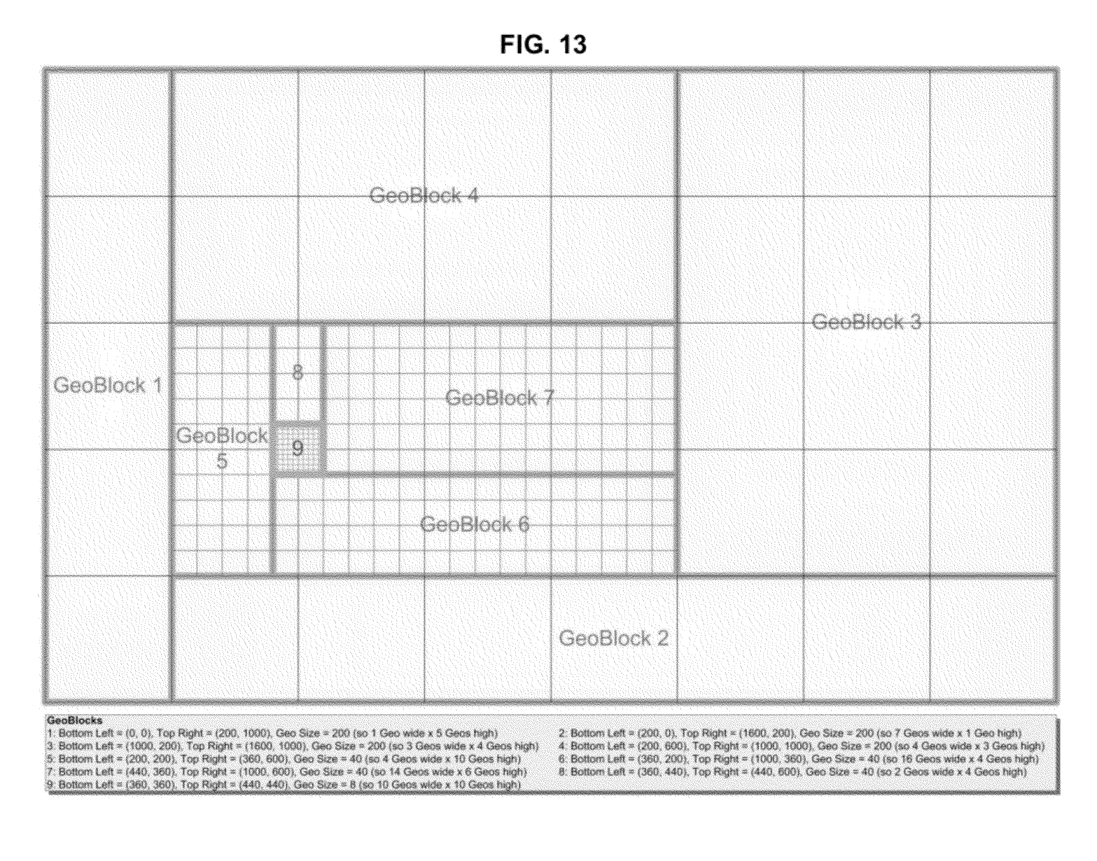

FIG. 13 illustrates the positioning of GeoBlocks containing different sizes of Geos. (To make the diagram easier to read, it shows three hypothetical sizes—200×200, 40×40 and 8×8—instead of the four actual sizes currently used in the UK game, 216×216, 24×24, 4×4 and 2×2, but the principles are the same.) GeoBlocks (i.e., the rectangles that define the locations of Geos) are the numbered rectangles with bold edges. Relatively large Geos are shown in GeoBlocks marked 1-4. Medium Geos are shown in GeoBlocks marked 5-8. Small Geos are shown in the GeoBlock marked 9.

In this example, a block of the smallest Geos are centred on the corner of where four of the largest Geos would otherwise meet. The small Geos are surrounded by medium Geos in all directions, and so the area of small Geos does not need to be extended much further than we would naturally want to (if it were surrounded by large Geos, we would have to extend the small Geos all the way out to the next large Geo grid lines).

It can also be seen from FIG. 13 that “inserting” a GeoBlock of small Geos in the middle of a GeoBlock of medium Geos results in the need for 4 extra GeoBlocks because each edge of the block of small Geos touches one of the block of medium Geos forming the “doughnut” around it. (If GeoBlock 9 were not present in the diagram above, then GeoBlocks 5-8 could be replaced by a single GeoBlock of medium Geos.)

Within each GeoBlock, there is a natural ordering of the grid of Geos it defines: starting with the bottom left one, moving left to right along the bottom row, then up to the next row, left to right along that and so on until the top right Geo is reached. For example, for a GeoBlock that is 4 Geos wide and 6 Geos tall, the ordering would be as shown as follows:

$$\begin{matrix}20 & 21 & 22 & 23 \\ 16 & 17 & 18 & 19 \\ 12 & 13 & 14 & 15 \\ 8 & 9 & 10 & 11 \\ 4 & 5 & 6 & 7 \\ 0 & 1 & 2 & 3\end{matrix}$$

GeoBlocks themselves can be ordered in a similar way (based on bottom left coordinates) or arbitrarily based on an identifier (ID). By combining the order of GeoBlocks and the order of Geos within each GeoBlock, a unique sequential integer ID can be derived for each Geo. This is important for the game draws, because then by choosing a number at random within the range of these IDs, the game organizer can offer “All Geo” draws where each Geo, regardless of size, has the same chance of winning.

According to one embodiment of the present invention, the following may be stored for each GeoBlock:
ID of this GeoBlock
ID of Map to which this GeoBlock belongs
ID of bottom-left Geo within this GeoBlock
Coordinates of south-west corner of this GeoBlock (e.g., in Cartesian coordinates (I, J))
Coordinates of north-east corner of this GeoBlock (e.g., in (I, J))
Size of each Geo within this GeoBlock. (Where Geos are always square, such as in (I, J) coordinates, the width and height of each Geo are the same, although being square in the (I, J) coordinate system is not necessarily the same as being square geographically.)

According to other embodiments, the following attributes may also be stored for each GeoBlock even though they can be derived from the other attributes, because it would be inefficient to have to calculate these additional attributes on the fly all the time:
Width of this GeoBlock in Geos
Height of this GeoBlock in Geos
ID of top right Geo within this GeoBlock
Coordinates of south-west corner of this GeoBlock in longitude-latitude co-ordinates.
Coordinates of north-east corner of this GeoBlock in longitude-latitude co-ordinates.

A GeoBlock is typically defined to be of such a size that its width and height are a multiple of the edge length of the Geos it contains.

Thus, using GeoBlocks, the locations of all Geos can be defined using far fewer records than if the coordinates of each Geo were explicitly recorded. At the same time, this mechanism allows one to vary the sizes of Geos and to ensure that there are no Geos in the middle of the sea. In particular, the GeoBlock mechanism described above makes it:
easy to calculate the total number of Geos and to map IDs to Geos,
easy to check whether a particular point on the map is in a valid Geo,
easy to check that no Geos overlap (because you only have to check that no GeoBlocks overlap),
easier to check there are no gaps between Geos (because you only have to check that there are no gaps between GeoBlocks).

### Historical Map State

Geos can be in three main states:
Vacant: the Geo is currently available.
Reserved: a user has chosen this Geo, but not paid for it yet.
Occupied: a user has paid for this Geo for the forthcoming draw.

The combined state of all Geos is referred to as the map state. The map state may be known not just for the current time, but also for any time in the past. This may be desirable to the current implementation of GeoSweep games for several reasons:
1. For auditing purposes;
2. If for any reason a prize draw cannot be started at the designated time, the draw can be run based on the historical map state;
3. Even if the draw is started at the designated time, the current map state may change while the draw is taking place. By using the map state from a specified timestamp, it does not matter how long the process of performing the draw takes.

Whenever a Geo changes state to a state other than vacant, a “Non-Vacant Geo” (NVG) record is made in the database. A Geo typically becomes non-vacant for a defined amount of time: reserved Geos typically can be reserved for a configured amount of time (e.g., 15 minutes), and occupied Geos are typically occupied for a set number of draws. Therefore, for each NVG record, both start and end timestamps can be stored. At the end timestamp, if no further action takes place, the Geo becomes vacant again. No special record needs to be made for vacant Geos: the absence of any record spanning a time period indicates that the Geo was vacant at that point. If a Geo moves from one non-vacant state to another, a new NVG record is made, and the end timestamp of the previous NVG record is set to the start timestamp of the new one. If a non-vacant state is extended (e.g., a user extends how long he or she wants to occupy the Geo for), then that record's end timestamp is increased accordingly.

### GeoGroups

A GeoGroup is a way for players to play together in a syndicate, much as is done on traditional lotteries. However, rather than the GeoGroup renting Geos in its own right, members of the GeoGroup can allocate some or all of their own Geos to the group. Each member continues to pay for the Geo(s) that he or she has allocated to the group. Any winnings by Geos in the GeoGroup are shared out amongst the group's Geos. For example, in a GeoGroup with 7 Geos allocated to it, if 2 of those Geos are allocated from person A, then person A may take 2/7 of all the group's net winnings.

According to some embodiments of the present invention, some or all of the following rules and/or conditions may be specified:
A Geo cannot be allocated to more than one GeoGroup at a time.
The Geos within a GeoGroup do not need to be next to each other.
In order to be a member of a GeoGroup, a user must have at least one Geo allocated to it.
If you are a member of the group, and your Geos go into a “Set Aside” state (which happens when payment for the Geo fails), then the Geos remain in the group, but do not count towards any winning.

### Map Breakdown Techniques

Described below are techniques for determining the location of GeoBlocks on a map. The breakdown of a map into GeoBlocks may be accomplished by the following stages:
1. Prepare the territorial and urban area boundary polygons.
2. Create un-optimized GeoBlocks based on the boundary polygons.
3. Remove small areas outside the main boundary that are not to be covered by any GeoBlock.
4. Create urban area Geos having an appropriate maximum Geo size.
5. Modify the size of Geos in special areas, such as points of interest.
6. Optimize the GeoBlocks such as to reduce the total number of GeoBlocks without changing Geo sizes or positions.

### Step 1: Prepare the Territorial and Urban Area Boundary Polygons

The first step is to obtain territorial data about the borders of the states or countries to be covered in GeoBlocks.

Boundary information can be obtained in ready-to-use polygon data formats (e.g., Shapefile, or one of a number of other GIS vector formats such as GML, KML, DLG or NTF), or can be derived from other forms of data such as raster area fills or sets of point samples. The data can be generated by governmental or professional surveying organizations (such as Ordnance Survey in the UK or USGS in the US), programmatically from satellite imagery, or using crowd-sourcing techniques.

The raw shape files from surveying organizations (which GeoSweep typically uses for current games) usually contain a lot of features of different types, and polygons are only one type of them. To make the algorithm work correctly, it may be desirable to extract all territorial boundary polygons, join as many of them as possible, and combine the remaining set of polygons into one large set of territorial boundary polygons.

The shape data about the urban area boundaries may also be combined into a set of urban area boundary polygons.

### Step 2: Create the Un-Optimized GeoBlocks

Once the territorial boundary polygons are established, the area delimited by the boundary polygons may be covered with GeoBlocks, usually without gaps or overlaps. These GeoBlocks initially contain Geos of the largest possible size. An exemplary procedure will be described after some information about grid coordinates.

Grid Coordinates

Referring to one example, grid coordinates may be set up as follows:
Each GeoBlock may be defined by four integer coordinates: I1, J1, I2, J2, where I corresponds to a position on the X axis, and J corresponds to a position on the Y axis.
The grid step (i.e., distance between the grid lines): according to one embodiment, the grid step may be 10 cm (in the Mercator map projection described below), the smallest Geo size for an exemplary map.
The start point (0, 0) of the grid is the origin, i.e., longitude 0, latitude 0.

Exemplary Procedure for Creating Un-Optimized GeoBlocks

A goal of this procedure is to keep GeoBlocks as large as possible, while avoiding extending far beyond the boundary of the groups of countries/states (or territory) to be covered. This can be achieved by iteratively dividing GeoBlocks that intersect any territorial boundary polygon into two, and removing any halves that are not within any polygon to be covered (The size of the Geos within the GeoBlocks can be one of a set of definable “allowed Geo sizes” for each territory):
1. Start with a large rectangular block that covers the whole set of boundary polygons and is made up of Geos of the “target” Geo size (the target size being the largest “allowed Geo size” for this run of the algorithm).
2. Cut the current block in half to create two smaller blocks, with a whole number of Geos in each. (Note that if the height or width is not divisible by two, the halves may be unequal. As a result of the later optimization step described below, whether a block is first cut horizontally or vertically does not make much difference to the final number of GeoBlocks produced. However, since preferring one direction over the other may help the later optimization step operate more efficiently, one approach may be to keep dividing the block vertically until the block is just one Geo tall in its currently-assigned Geo size, and only then divide horizontally.) For each of these new blocks continue independently to the next step.
3. Check whether the block intersects with any of the boundary polygons (see further description on this below)
   a. If yes: determine (1) whether the block has the size of the “target” Geo size (i.e., its height and width are just one Geo of target size) and (2) whether the block is entirely inside the boundary of a polygon
      i. If yes (i.e., either condition (1) or condition (2) is true): set its Geo size to the target size and add it to the GeoBlock results set.
      ii. If no (i.e., both condition (1) and condition (2) are false): if the height or width of the current block is just one Geo in its currently-assigned Geo size, then assign it the next smaller of the “allowed Geo sizes”, then go to step 2 for this block.
   b. If no: discard the block.

A similar process may take place after removing small areas, using the blocks output from the above as the starting point, but considering the urban boundary polygons to ensure that urban areas have an appropriate (definable) maximum Geo size. This is basically the same process as above, but (i) with a subset of the “allowed Geo sizes” (so not using some of the larger general “allowed Geo sizes”), (ii) using the urban area boundary polygons instead of the territorial boundary polygons, and (iii) blocks are not discarded in step 3b.

To check whether a GeoBlock intersects with the edges of the boundary polygons, the GeoBlock's grid coordinates can first be converted into the longitude/latitude coordinates that the boundary polygons use. At least two types of coordinate system could be used in practice, although the latter (see 2 below) is the only one used by a current embodiment of the GeoSweep game.

1. Linear dependence. Here there is a simple linear relationship between the longitude/latitude coordinates and the position on a two-dimensional map.

longitude(i) = longitude0 + i*step_longitude;
latitude(j) = latitude0 + j*step_latitude;
where
step_longitude, step_latitude are fixed steps (~200m
on the map center),
latitude0, longitude0 are start point of the map

2. Non-linear dependence (Mercator specific transformations). A commonly used map projection is the Mercator projection. Latitude/longitude values are not linearly related to the position on a two-dimensional map and must undergo a transformation first.

longitude(i) = longitude0 + i*step_longitude;
latitude(j) = latitude(j−1) +
step_latitude(latitude(j−1));
where
step_latitude(lat) = step_latitude *
cos(lat)/cos(lat_center),
lat_center - is the latitude of map center

A special case exists for GeoBlocks around the antimeridian—i.e., the meridian which is both 180 east and 180 west (or −180 east) from the Prime Meridian at zero longitude. In order to avoid dealing with GeoBlocks having non-contiguous longitude values, the map breakdown may be performed in such a way that blocks can touch the longitude −180/180, but will never contain them. For example, if there is an area containing the antimeridian then blocks covering it will terminate at longitude 180 and other blocks will start at longitude −180.

Since the Geos in a block may be of differing sizes, it could be that doing this naively would lead to gaps in the coverage of Geos at the antimeridian. In order to avoid that situation, two distinct map breakdowns can be performed.

First, all polygons touching longitude −180 are collected by intersecting them with the rectangle (−180,−90)−(−179.999,90). These intersecting polygons are split into two. Then, a map breakdown using an initial block which spans the east half of the intersecting polygons from longitude −180 eastwards is performed. Next, a map breakdown with all the other polygons (those that do not span the antimeridian) is performed by using an initial block which extends from longitude +180 westwards. The first of these map breakdowns only generates blocks for areas spanning the antimeridian, so most of the blocks are generated by the second map breakdown. The order of these two map breakdowns is not important.

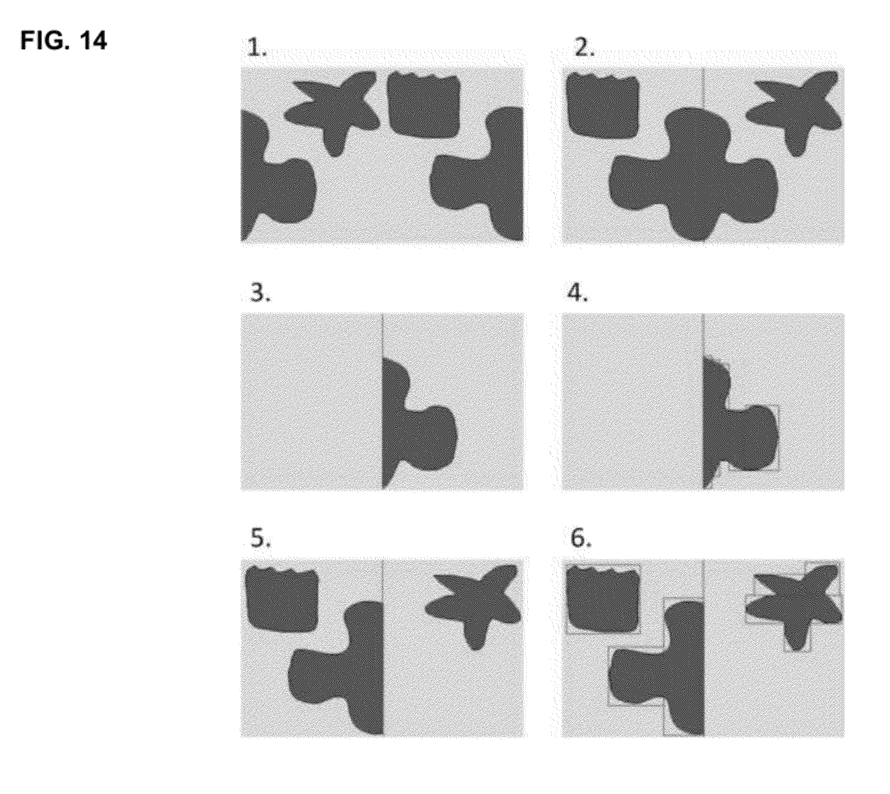

Referring to FIG. 14 as an illustration, imagine the shapes shown in the images as representing the world map. Image 1 is the map centred on zero longitude; image 2 shows the map centred on the antimeridian (marked by the central vertical line). Image 3 and 5 show the map polygons having been split along the antimeridian. Images 4 and 6 are the map breakdowns that are performed on images 3 and 5 respectively.

### Step 3: Remove Small Areas

Islands of GeoBlocks that have an area less than a specified threshold are then removed. This is to avoid covering small islands of little interest (and often bad image resolution in Google Maps, some way off the coast). According to one particular embodiment, for the UK map, a threshold of an area equivalent to 20 large Geos was set, which threshold was found by trial-and-error to result in a suitable set of removed islands.

### Step 4: Create Urban Area GeoBlocks

This may be performed based on a procedure such as the “Exemplary Procedure for Creating Un-optimized GeoBlocks” described above, but (as described in that section), using the urban boundary polygons to ensure that urban areas have an appropriate (definable) maximum Geo size. This is done using the same process as for the initial breakdown, but (i) with a subset of the “allowed Geo sizes” (so not using some of the larger general “allowed Geo sizes”), (ii) using the urban area boundary polygons instead of the territorial boundary polygons, and (iii) blocks are not discarded in step 3b.

For example, for the UK map in one embodiment, urban area GeoBlocks are given a “target” Geo size of 24×24 metres.

### Step 5: Modify the Geo Sizes at Points of Interest

Based on specific needs for map breakdown, there may be some other types of area where Geo sizes are further modified. For example, a goal of this step may be to cover points of interest with smaller-sized Geos so that more people may rent Geos in such areas. It is therefore desirable to modify the existing set of GeoBlocks so it contains GeoBlocks with smaller Geo sizes in these areas.

For instance, there may be the following types of “points of interest”:
1. Specific points of interest where a Geo block and the size of its Geos could be manually defined. An example would be a sports stadium. A set of GeoBlocks representing the point of interest can be created manually.
2. Exclusion areas. Rather than being areas of smaller Geos, they are areas of no Geos at all. But the same procedure could be used to “include” them on the map.

Geo sizes for points of interest may be selected or specified. For example, for the UK map in another embodiment, specific points of interest may be given Geos of size 4×4 metres or 2×2 metres, depending on the anticipated popularity of the area, and the quality of imagery available.

Exemplary Procedure for Modifying Geo Sizes at POI

For each point of interest (POI), the set of un-optimized GeoBlocks may be processed to make it include the POI. Virtual POI GeoBlocks of each relevant Geo size are created that cover the POI. These virtual POI GeoBlocks, along with the POI GeoBlocks themselves, are then integrated in descending order of Geo size into the existing set of map GeoBlocks. The reason for these virtual POI GeoBlocks is to avoid converting large Geos into small Geos, when an intermediate size could be used. What follows is a description of an exemplary procedure, followed by illustrative examples.
1. Create new GeoBlocks representing POIs (note that a POI can be represented by multiple GeoBlocks)
   a. Manually create specific points of interest GeoBlocks.
   b. Manually create exclusion areas GeoBlocks.
2. Adjust the I and J coordinates of the POI GeoBlock so that the edges are aligned with the grid lines of Geos that have the next size up from the POI GeoBlock's Geos. That is, adjust the I1 coordinate of the POI GeoBlock so that it is equal to the I value of the next vertical gridline of Geos of size (POI GeoBlock Geo size+1) to the west. Then repeat with a similar process to the east, south and north. (If the POI GeoBlock's Geos are of the largest size, then align it by its own Geo size instead).
3. For each POI GeoBlock that was created in step 1
   a. For each map GeoBlock that intersects with the POI GeoBlock
      i. For each Geo size GS between the POI GeoBlock's Geo size plus 1, up to the existing map GeoBlock's Geo size minus 1:
         (1) Create a virtual POI GeoBlock with Geos of size GS. Set its coordinates to be the same as the original POI GeoBlock, but adjusted so that the edges are aligned with the grid lines of Geos of size (GS+1). (Step 2 above explains this in a little more detail).
4. For each real and virtual POI GeoBlock, in descending Geo size order
   a. For each map GeoBlock that intersects the POI GeoBlock
      i. If the map GeoBlock is within the POI GeoBlock, discard it.
      ii. If the POI GeoBlock's J2 coordinate (PJ2)—i.e., the north face—is between J1 and J2 of the map GeoBlock
         (1) Split the map GeoBlock along that edge. In other words, replace the map GeoBlock (I1, J1, I2, J2) with two new GeoBlocks (I1, J1, I2, PJ2) and (I1, PJ2, I2, J2).
         (2) Adjust the new map GeoBlocks' Geo sizes to be the largest possible size where the gridlines for that Geo size still align with the edges of the new map GeoBlocks.
         (3) Remove the original map GeoBlock from the list, add the two new map GeoBlocks to the end of the list and go to step 4 a).
      iii. If no splitting was necessary in step ii), perform step ii) but for the south face of the POI block instead.
      iv. If no splitting was necessary in step ii) or iii), perform step ii) but for the west face of the POI block instead (working with the I coordinates instead of the J coordinates).
      v. If no splitting was necessary in steps ii) to iv), perform step ii) but for the east face of the POI block instead (working with the I coordinates instead of the J coordinates).
   b. Add the POI GeoBlock to the list of map GeoBlocks.

### Illustrative Examples

The examples are split into three. The first illustrates the process and result obtained when using the full procedure. There are then examples to illustrate what happens if virtual POI GeoBlocks are not used or if POI GeoBlocks are not aligned to gridlines of Geos the next size up.

The diagrams in each version show how a GeoBlock is split into multiple GeoBlocks due to the presence of a POI. For simplicity, in this example the POI itself is defined by just one GeoBlock, is completely enclosed in just one original map GeoBlock, and there are only three possible sizes of Geo.

### A. Example Using Full Procedure

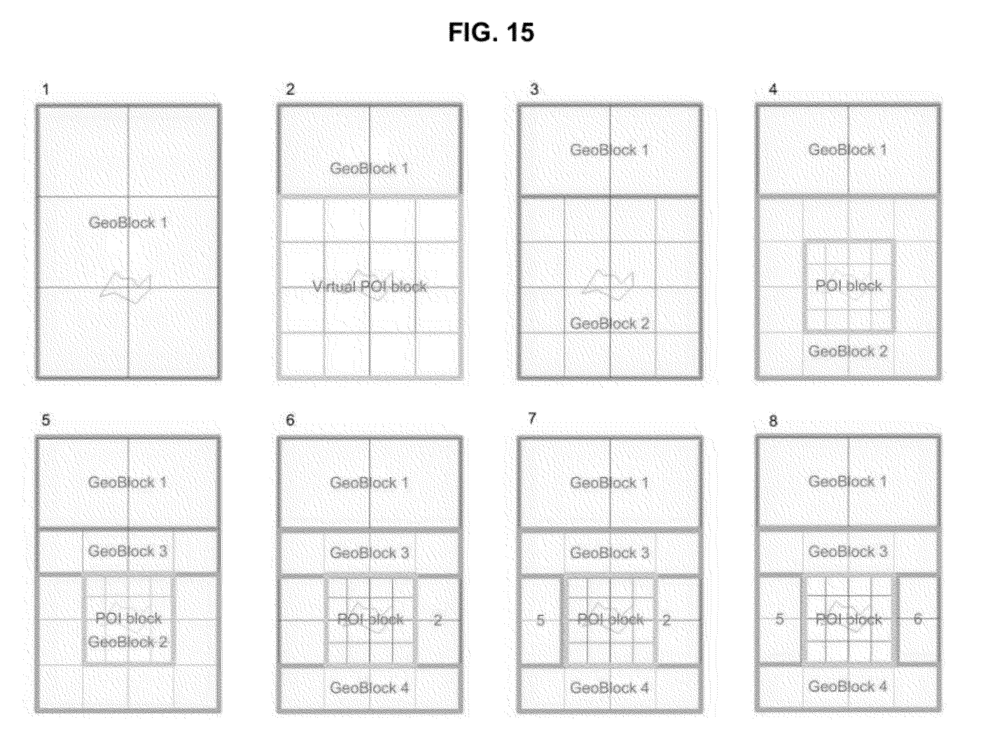

As illustrated in FIG. 15, Step 1 shows the original map GeoBlock, and the POI polygon. Step 2 shows the intersection of the GeoBlock with a newly created virtual POI GeoBlock. The size of the virtual POI's Geos is one less than the original GeoBlock's Geos. The size of the virtual POI GeoBlock is large enough to cover the POI and at the same time its I and J values are set such that they align with the grid of the large Geos that the original GeoBlock is composed of. Step 3 illustrates the splitting of GeoBlock 1 along the Virtual POI boundary, resulting in a smaller GeoBlock 1 and the virtual POI block (renamed as GeoBlock 2).

Note that if there were more sizes of Geos, extra virtual POI GeoBlocks would be created and used, covering all Geo sizes from the original map GeoBlock Geo size minus 1 down to the POI Geoblock Geo size plus 1.

Step 4 shows the POI block overlayed on the underlying GeoBlock. The edges of the POI block are made to align with the grid of the medium-sized Geos that GeoBlock 2 has.

Steps 5, 6, 7 and 8 show the sequential splitting of GeoBlock 2 along the boundaries of the POI block, into GeoBlocks 3, 4, 5 and 6 plus the actual POI block.

The end result is a set of six GeoBlocks, where no Geo has been unnecessarily turned into smaller Geos.

### B. Example without Using Virtual POI GeoBlocks

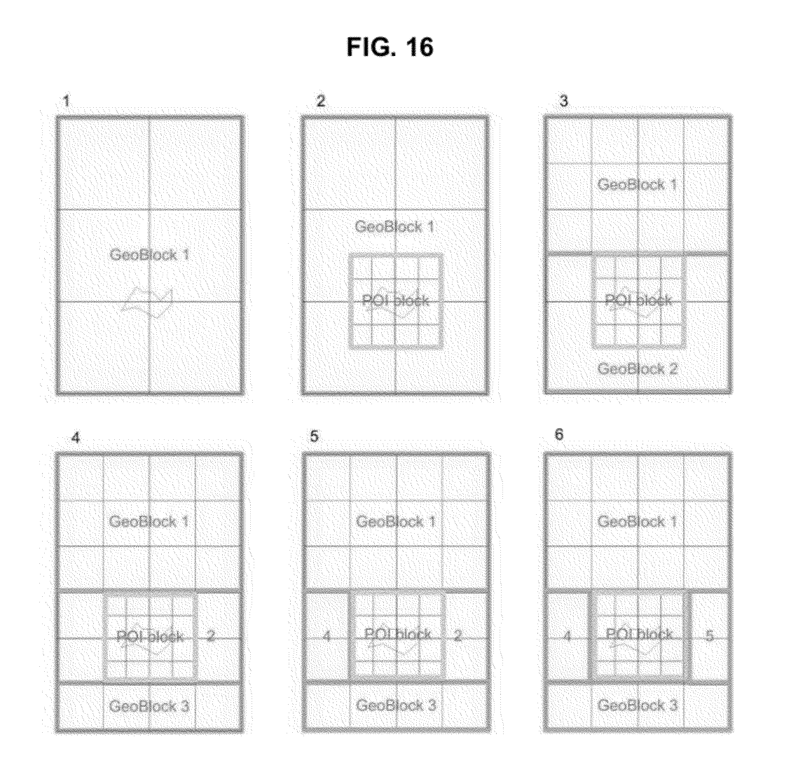

In the example illustrated in FIG. 16, the absence of the virtual POI means that in step 3, GeoBlock 1 has to be converted to medium-sized Geos as the GeoBlock's edges do not align with the large-sized Geo gridlines. The corresponding area in the previous example mostly consists of two large Geos, which is preferable.

### C. Example with No Aligning of POI GeoBlocks to Gridlines of Geos the Next Size Up

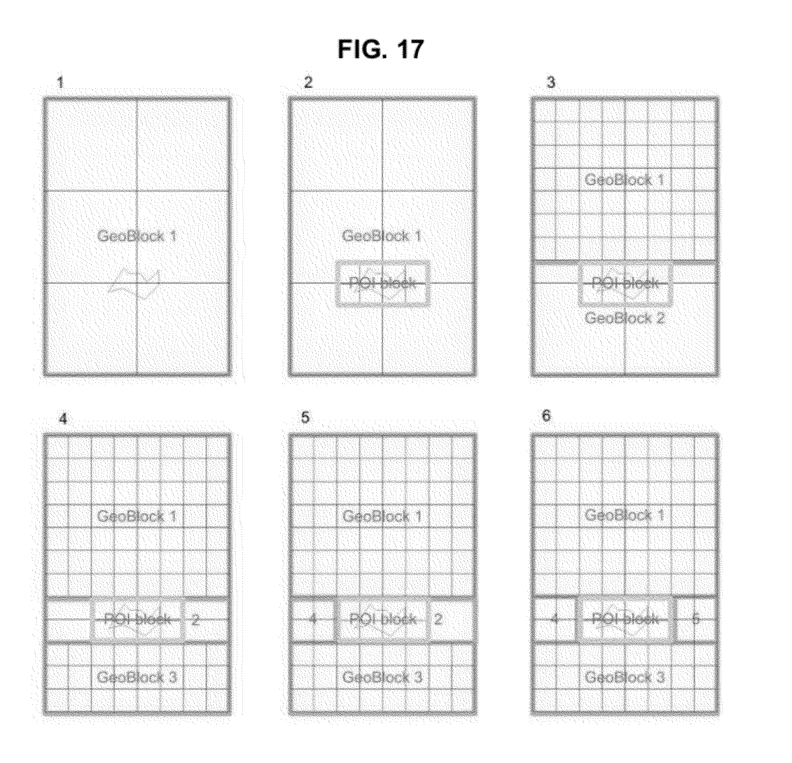

In the example illustrated in FIG. 17, it can be seen that, by not aligning the POI GeoBlock with the gridlines of Geos the next size up (the medium Geos), all of the area is ultimately converted into small Geos.

### Step 5: GeoBlock Optimization

The set of GeoBlocks created so far is un-optimized. That is to say, the map's Geos could be represented with fewer GeoBlocks. The GeoBlocks can be optimized by joining adjacent GeoBlocks that have same-sized Geos. Note that this optimization procedure could be run between Steps 2 and 3, or elsewhere if necessary.

### Exemplary Procedure for Optimizing GeoBlocks

An objective of the procedure is to examine if the north/south or east/west sides of a GeoBlock exactly match up with the sides of one or more other GeoBlocks. This can be done as follows:
1. For each GeoBlock A
   a. See if the east side of A can be expanded:
      i. Check if another GeoBlock B exists such that B(I1, J1)=A(I2, J1). That is, the west side of B is next to the east side of A, and the south faces of B and A are in line with each other. Also check that the Geo sizes in B and A are the same. If any of these checks is false, GeoBlock A cannot be expanded to the east.
      ii. If B(J2)>A(J2) then B is taller than A, and an expansion of A to the east cannot be accomplished as its north/south sides are not in line with another GeoBlock to the east.
      iii. If B(J2)<A(J2)
         (1) Check if GeoBlock C exists such that C(I1, J1)=B(I1, J2). That is, the west side of C is in line with the west side of B, and the south face of C is next to the north face of B. Also check that C and B's Geo sizes are the same. If any of these checks is false, GeoBlock A cannot be expand to the east.
         (2) If C(J2)<A(J2) then repeat the previous sub-step (looking for a new GeoBlock D and comparing it with C, and so on).
      iv. If A(J2)=B(J2), or A(J2)=C(J2) or D(J2) etc, then the north faces are in line and a set of GeoBlocks are identified whereby A can be expanded to the east and the others contracted. In this case, increase A(I2) by one Geo width, and increase I1 of the other GeoBlocks by one Geo width.
         (1) If any of the GeoBlocks have new size of zero, remove them.
      v. Go back to step a) until no more expansions are possible for that GeoBlock in that direction.
2. Repeat this process for the north sides of each GeoBlock, then the south sides, then the west sides.
3. Repeat the whole process until no more expansions are possible. The whole process needs to be re-run (possibly multiple times) as by performing expansions in one direction, it may enable more expansions in another direction that were not possible the first time expansions in that direction were performed.

### Illustrative Example

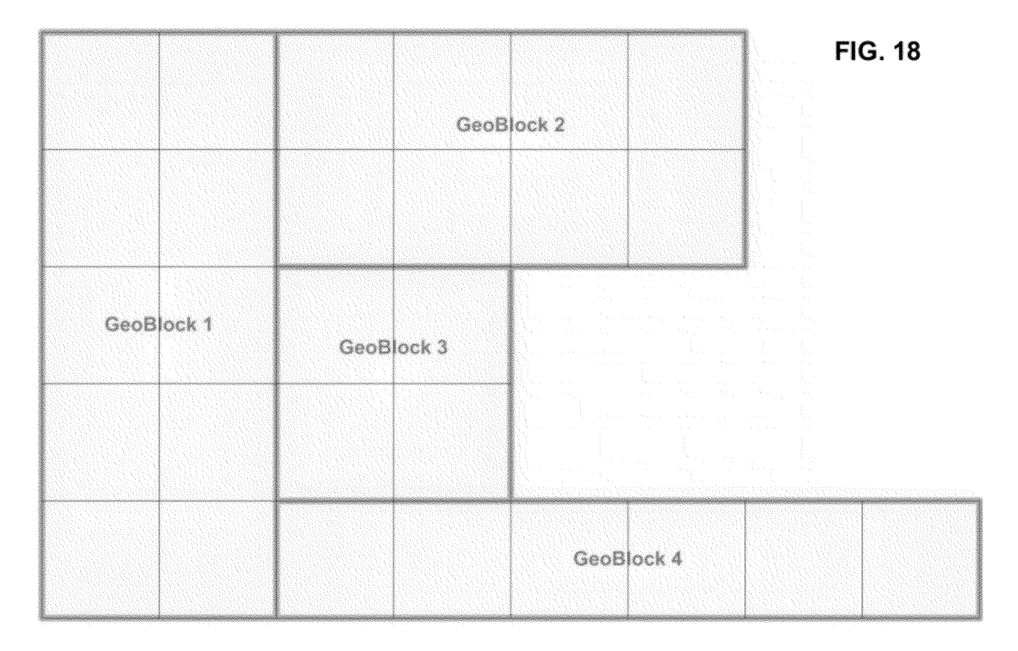

FIG. 18 shows one example of un-optimized GeoBlocks.

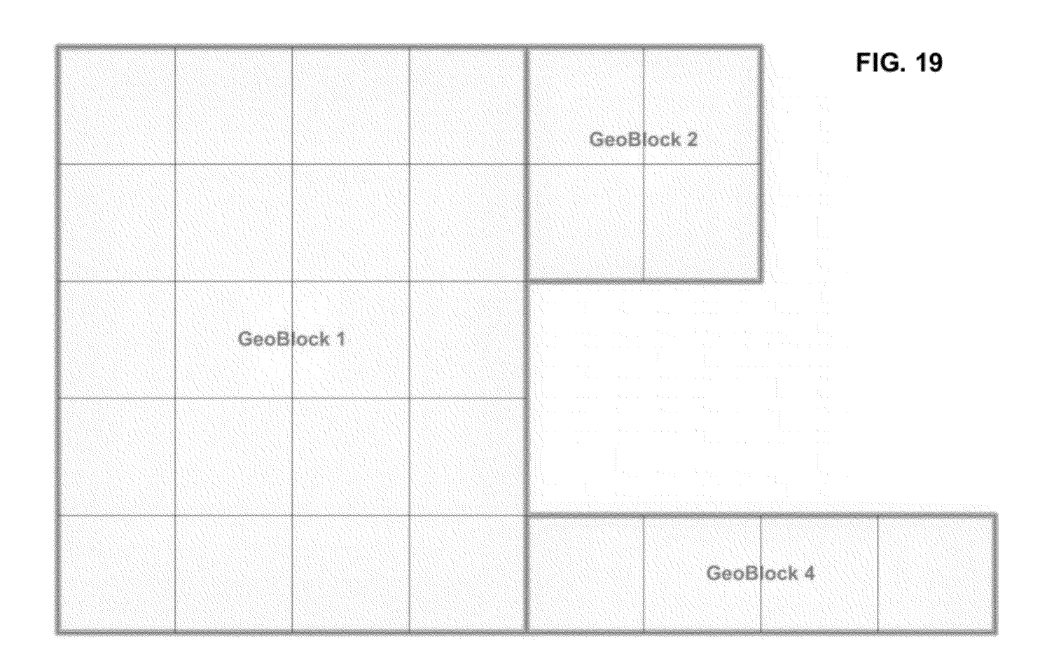

By administering the optimizing algorithm, GeoBlock 1 is expanded to the right to include parts of GeoBlocks 2 and 4, and all of GeoBlock 3. The total number of blocks is thus reduced from 4 to 3, as shown in FIG. 19.

### The End Result

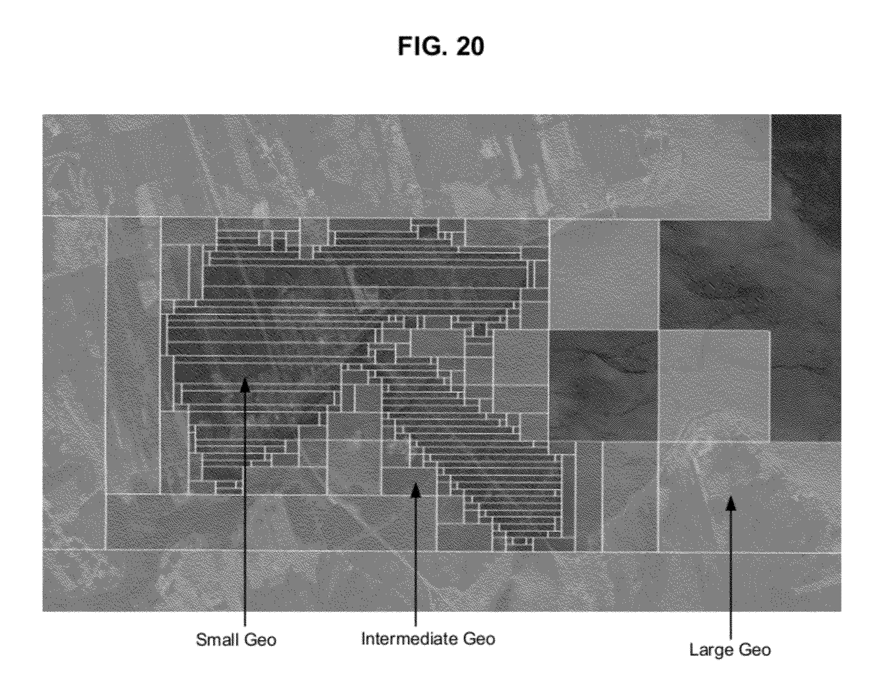

FIG. 20 is an exemplary image of a section of map once the generation and optimization are successfully finished. It illustrates an urban area near a coast line. The white lines are GeoBlock boundaries. Different Geo sizes are illustrated by different shades of gray; the smaller the Geo size, the darker the shade. The areas with no shading are outside the map boundary and therefore are not covered in Geos. The urban area itself is of small Geo size (indicated by the darkest shade). The outer areas on the diagram are of a large Geo size (lightest shade). In between the small and large Geo areas are GeoBlocks with Geos of various intermediate sizes, indicated by other shades of gray.

### Transfer and Display of Map Information

When a user views the map using a GeoSweep user interface, a Google Map may be displayed with overlaid information about Geos and prize draws. Some techniques may reduce or minimize the amount of information transferred between server and web browser, and reduce or minimize the grid lines that are drawn.

### Data Transfer

According to one embodiment of the present invention, the basic process for obtaining the map data may proceed as follows:
1. The JavaScript in the browser queries Google Maps for the coordinates of the current viewport (the area of the map that is currently showing on the user's screen).
2. It then modifies the coordinates of this viewport to enlarge it by a configurable percentage (e.g., 60%). This is so that if the user scrolls the map or zooms out, information about all or some of the newly on-screen map area can be instantly shown.
3. It then sends a request for information about the new viewport area to the server (along with the location of the old viewport area that it already knows about). The server then responds with all appropriate information, namely:
   a. GeoBlocks that are in the new viewport area (partially or completely) but which are not already known to the client (i.e., which do not overlap the old viewport area—thereby reducing the amount of data needed to send back on small moves of the map, for example).
   b. Prize footprints that are visible
   c. Basic details about ‘foreign’ Geos, i.e., Geos occupied by other users.

Details of a user's own Geos are requested by the browser separately as they are also used in other parts of the application.

GeoBlocks, as explained earlier in this document, are an efficient way of representing the layout of Geos and by only sending details of GeoBlocks not already cached at the client, the data transferred have already been reduced. Information about prize footprints is relatively small and needs little (if any) optimization. The representation of foreign Geos, on the other hand, can be optimized significantly. This will now be described.

Procedure to Produce an Efficient Foreign Geo List Representation

For each GeoBlock
1. Record the full ID of the first foreign Geo.
2. For each subsequent foreign Geo, record the Geo's ID with (previous foreign Geo's ID+1) subtracted. This makes the number representing each subsequent foreign Geo as small as possible. Also record some basic information about the Geo, which can be represented as a set of bit flags (i.e., each piece of information can be represented by a ‘yes’ or ‘no’ answer, and can thus be represented by a 0 or 1 in one bit, which is the smallest unit of computer data storage).
3. Run-length encode the information about Geo IDs. Run-length encoding converts sequences where the same data value occurs many times in a row into a single data value and count.

### Illustrative Example

In the following GeoBlock, Geos highlighted in red are foreign Geos and the others are vacant:

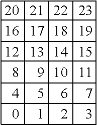

The foreign Geo IDs can be represented as:

[4,5,6,7,8,9,10,11,13,14,15]

They can also be represented as a single full ID followed by (new foreign Geo ID minus (previous foreign Geo ID plus 1)):

[4,0,0,0,0,0,0,0,1,0,0]

Applying run-length encoding to this can lead to an optimized representation:

[1×4,7×0,1×1,2×0]

### Grid Line Drawing

Once the browser has the Geo data, the grid lines that mark out the boundaries of each Geo are drawn on the map. Foreign Geos and the Prize Footprint rectangle are also drawn. A couple of complications arise with drawing the Geo grid lines:
GeoBlocks that are only partially within the enlarged viewport rectangle should only have the lines within the enlarged viewport drawn. Drawing long lines out of this area is not optimal and can cause problems in browsers.
Because the lines are partially transparent, each line must be drawn only once to avoid any lines appearing more boldly than others. This is done by creating one set of lines that is the union of all lines to be drawn, before then drawing them.

### Exemplary Procedure for Drawing Grid Lines

1. For each GeoBlock, create lines representing the boundaries of the GeoBlock and the Geos within it.
2. For each line, truncate the lines so that they end at the boundaries of the enlarged viewport.
3. Create a set of lines that represents the union of the original list of lines such that each piece of line is only drawn once.

The techniques disclosed herein for storing and processing map data may be implemented in a client-server environment involving one or more central gaming servers (typically with databases or other data storage) in communications with client computing devices which may be desktop, laptop, or tablet computers, mobile devices (e.g., smart phones), retail lottery terminals, gaming kiosks, or casino gaming terminals. Alternatively, these techniques may be implement on computing devices for various other applications such as mapping, geo-location, and image processing wherever there are needs for decomposing a map or image into constituent blocks or units for identification, storage, transfer, or display.

### Draw and Prize Calculation

### Prize Footprint

As well as the main prize, the current GeoSweep games offer a runners-up prize. This prize is shared amongst any occupied Geos falling within the Prize Footprint of the winning Geo.

The Prize Footprint can be determined by taking the bounding edges of the winning Geo and extending them outwards equally in each direction such that the Footprint covers all or part of at least 100 other Geos. Any occupied Geos (besides the winning one) falling at least partly inside the Prize Footprint share the runners-up prize.

### Illustrative Example

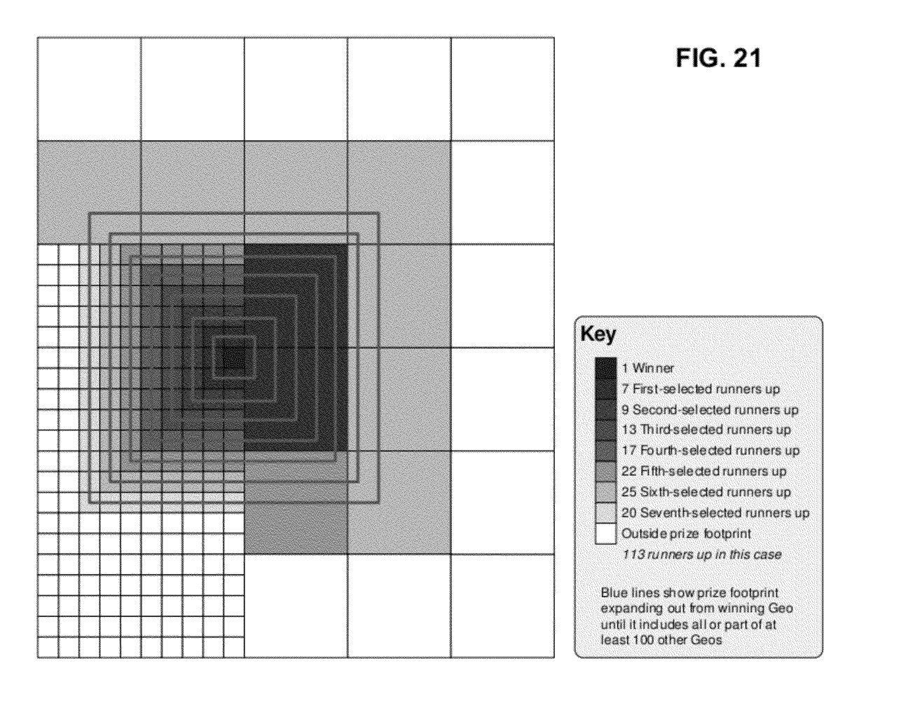

FIG. 21 is a diagram illustrating the expansion of the Prize Footprint area until at least 100 Geos are fully or partially covered by the footprint.

### Exemplary Procedure for Identifying Prize Footprint

In practice, rather than iteratively expanding the Prize Footprint, a more optimal binary search procedure may be followed. It calculates the largest possible rectangle that 100 Geos could occupy, the smallest possible rectangle, and a middle-sized rectangle. The middle rectangle is assessed for how many Geos it covers. It is then known whether the Footprint boundary lies between the small and middle size, or between the middle and large size, thereby dividing the search space into two. The search space can continue to be divided into two in this fashion until the correct rectangle size has been found.

1. Let Geo (I, J) be the winning Geo

2. Construct inner rectangle
IR=[(I−1, J−1), (I+1, J+1)]

Construct Outer Rectangle
OR=[(I−K, J−K), (I+K, J+K)],
where K=0.5*sqrt(100)*LARGE/SMALL,
LARGE denotes size of the largest Geo
SMALL denotes size of the smallest Geo

3. Construct middle rectangle
MR=[(OR.I1+0.5*(IR.I1−OR.I1), OR.J1+0.5*(IR.J1−OR.J1)), (IR.I2+0.5*(OR.I2−IR.I2), IR.J2+0.5*(OR.J2−IR.J2))]

4. Check how many Geos are covered by middle rectangle:
a. If >100
   i. If (IR.i1−MR.i1>1) then make OR=MR and go to step 4;
   ii. Otherwise return all Geos covered by MR;
b. If<100
   i. If (MR.i1−OR.i1>1) then make IR=MR and go to step 4;
   ii. Otherwise return all Geos covered by OR;
c. Otherwise return all Geos covered by MR.

Displaying the Prize Footprint

When a user chooses to see a draw's Prize Footprint, it is desirable that all the Prize Footprint is shown on the screen. Information about the position and size of the Prize Footprint square is passed to Google Maps, which then ensures an appropriate map zoom level is used such that the entire footprint fits on the screen.

### Prize Calculation

For each draw, there is a prize pot. The winning Geo receives a configurable percentage of this, and the remaining percentage is divided amongst the runners-up Geos.

### Exemplary Procedure for Prize Calculation

1. A temporary prize amount is assigned to each prize-winning Geo. Prize-winning Geos are of two types:
   a. The Geo that has won the main prize.
   b. The runners-up Geos in the Prize Footprint. The runners-up prize is divided equally between the runners-up Geos according to one embodiment of the present invention.
2. For each prize-winning Geo, if it is in a GeoGroup, assign the Geo's prize to the group and remove the Geo's own prize. If the group already has a prize, add the new one to it.
3. For each prize-winning GeoGroup:
   a. Deduct any charity donations that have been chosen by that GeoGroup.
   b. For each Geo in the GeoGroup, assign a prize to the Geo that is equal to the GeoGroup's prize divided by the number of active Geos in the group.
4. For each Geo with a prize
   a. Assign the Geo's prize to the Geo's owner. If the user already has a prize, add the new one to it.
5. For each prize-winning user
   a. Round the prize value according to the rounding rules:
      i. Rounding of prizes is always down, to the nearest pound.
      ii. If the user's prize is rounded down to £0, round the prize up to the nearest ten pence and convert the prize into Geo credits (e.g., a Geo credit allows a user to rent a Geo for one day). Thus a prize of 53p is converted into 60p's worth of Geo credits, or 6 Geo credits.
   b. Assign the prize to the user's account.
      i. For small cash amounts, payment is made automatically to the user's registered payment card.
      ii. Any Geo credits are credited automatically to the user's GeoSweep account.
      iii. Large cash amounts are paid manually to the user.

### Prize Rollover

Often, some money is left in the prize pot after prizes have been allocated. It mostly consists of the following:
1. The runners-up prize in draws where there are not any runners-up Geos.
2. Small sums resulting from rounding down prizes to the nearest pound.

If the rollover feature of the GeoSweep game is enabled, this left-over money is added to the rollover fund. It is possible to configure the system to then allocate all of the rollover fund to the next day's prize pot, or a set amount. If any part of a rollover fund is not allocated to a prize pot, the money stays in that rollover fund.

Prize Insurance

It is possible to configure the GeoSweep system to pay an insurance premium in order to cover the cost of large prizes. The amount subtracted from the prize pot for the insurance premium is a multiple of the number of Geos in the draw (currently around 3p per Geo for the GeoSweep prize. This is in practice paid up front in a block—e.g., 20 million Geos, with 6 months to use them.)

### Illustrative Example

Here's an example to illustrate how the prize pot and rollover are calculated.

Given the following:
Number of Geos entered into the draw=1 million
Prize amount added to the prize pot per Geo=3.3p per Geo
Insurance cost=3p per Geo
Rollover fund=£10 k
Insured amount=£1.1 million

Then:
Prize amount from Geos in the draw=3.3p×1 million=£33 k
Insurance cost=3p×1 million=£30 k
Prize pot=(Insured amount+Amount from Geos−Insurance cost+Rollover fund)=£1.113 million
If no one wins, Rollover the next day=(Amount from Geos−Insurance cost+Today's rollover fund)=£13 k

While the foregoing description includes many details and specificities, it is to be understood that these have been included for purposes of explanation only, and are not to be interpreted as limitations of the present invention. It will be apparent to those skilled in the art that other modifications to the embodiments described above can be made without departing from the spirit and scope of the invention. Accordingly, such modifications are considered within the scope of the invention as intended to be encompassed by the following claims and their legal equivalents.

1. A computer-implemented method for handling map or image data, the method comprising:
dividing, by at least one processor, a map or image into a plurality of non-overlapping rectangular blocks, wherein each of said plurality of blocks consists of an array of non-overlapping rectangular units and each of the units within the same block is of a same defined size;
assigning, by at least one processor, each of said plurality of blocks a unique block identifier;
indexing, by at least one processor, the units within each block based on a predetermined order, thereby assigning each unit an index number that is unique with respect to the other units within the same block;
generating, by at least one processor, a unique unit identifier for each unit in said map or image by combining (a) said block identifier of the block in which said each unit is located and (b) said index number of said each unit within said block;
storing in at least one storage medium, for each block in said map or image, its block identifier and a set of coordinates specifying its location in said map or image; and
storing in at least one storage medium, for each unit, its unit identifier.

2. The computer-implemented method according to claim 1, further comprising:
extracting, from said map or image, data representing boundary shapes of said map or image; and
dividing iteratively said map or image into an initial set of non-overlapping rectangular blocks based on said data representing boundary shapes and a list of desired unit sizes for specified areas of said map or image.

3. The computer-implemented method according to claim 2, further comprising generating said plurality of non-overlapping rectangular blocks by performing one or more of:
removing, from said initial set, any outlier or undesirable block,
dividing each of said initial set of blocks into an array of units having the same unit size based on the list of desired unit sizes, and
consolidating at least some of said initial set of blocks into new, rectangular blocks.

4. The computer-implemented method according to claim 1, further comprising:
establishing a prize game using at least part of said map or image as a gameboard;
receiving, from each of a plurality of players, a game entry comprising a selection of at least one of the units on the gameboard;
recording said each player's game entry in connection with the unit identifier of the selected at least one unit; and
drawing, randomly from the unit identifiers of some or all of the units on the gameboard, to select one or more units to win a prize.

5. The computer-implemented method according to claim 4, further comprising:
recording a historic state of each unit in connection with its unit identifier to at least indicate whether, at a point in time, said each unit is vacant or selected by a player.

6. The computer-implemented method according to claim 5, further comprising:
conducting the random drawing based on the historic state of said some or all of the units on the gameboard.

7. The computer-implemented method according to claim 4, further comprising:
transmitting at least a portion of said gameboard for display on a client computing device.

8. The computer-implemented method according to claim 7, further comprising:
receiving from said client computing device a request for gameboard information;
identifying blocks extending beyond a first area of said gameboard currently displayed on said client computing device and overlapping an extended area defined with respect to said first area; and
transmitting data related to said identified blocks to said client computing device.

9. The computer-implemented method according to claim 8, further comprising:
placing a script in a web page or application to be downloaded to said client computing device, wherein the script, when executed on said client computing device, performs the following:
identifying said first area of said gameboard currently displayed; and
generating coordinates representing said extended area.

10. The computer-implemented method according to claim 1, wherein said predetermined order traces units within a block by starting from a first of said units and following a linear path through the rest of said units.

11. A system for handling map or image data, the system comprising at least one processor and at least one storage medium wherein the at least one processor is adapted to perform:
dividing a map or image into a plurality of non-overlapping rectangular blocks, wherein each of said plurality of blocks consists of an array of non-overlapping rectangular units and each of the units within the same block is of a same defined size;
assigning each of said plurality of blocks a unique block identifier;
indexing the units within each block based on a predetermined order, thereby assigning each unit an index number that is unique with respect to the other units within the same block;
generating a unique unit identifier for each unit in said map or image by combining (a) said block identifier of the block in which said each unit is located and (b) said index number of said each unit within said block;
storing, for each block in said map or image, its block identifier and a set of coordinates specifying its location in said map or image; and
storing, for each unit, its unit identifier.

12. The system according to claim 11, the at least one processor being further adapted to:
extract, from said map or image, data representing boundary shapes of said map or image; and
divide iteratively said map or image into an initial set of non-overlapping rectangular blocks based on said data representing boundary shapes and a list of desired unit sizes for specified areas of said map or image.

13. The system according to claim 12, the at least one processor being further adapted to generate said plurality of non-overlapping rectangular blocks by performing one or more of:
removing, from said initial set, any outlier or undesirable block,
dividing each of said initial set of blocks into an array of units having the same unit size based on the list of desired unit sizes, and
consolidating at least some of said initial set of blocks into new, rectangular blocks.

14. The system according to claim 11, the at least one processor being further adapted to:
establish a prize game using at least part of said map or image as a gameboard;
receive, from each of a plurality of players, a game entry comprising a selection of at least one of the units on the gameboard;
record said each player's game entry in connection with the unit identifier of the selected at least one unit; and
draw, randomly from the unit identifiers of some or all of the units on the gameboard, to select one or more units to win a prize.

15. The system according to claim 14, the at least one processor being further adapted to:
record a historic state of each unit in connection with its unit identifier to at least indicate whether, at a point in time, said each unit is vacant or selected by a player.

16. The system according to claim 15, the at least one processor being further adapted to:
conduct the random drawing based on the historic state of said some or all of the units on the gameboard.

17. The system according to claim 14, the at least one processor being further adapted to:
transmit at least a portion of said gameboard for display on a client computing device.

18. The system according to claim 17, the at least one processor being further adapted to:
receive from said client computing device a request for gameboard information;
identify blocks extending beyond a first area of said gameboard currently displayed on said client computing device and overlapping an extended area defined with respect to said first area; and
transmit data related to said identified blocks to said client computing device.

19. The system according to claim 18, the at least one processor being further adapted to:
place a script in a web page or application to be downloaded to said client computing device, wherein the script, when executed on said client computing device, performs the following:
identifying said first area of said gameboard currently displayed; and
generating coordinates representing said extended area.

20. The system according to claim 11, wherein said predetermined order traces units within a block by starting from a first of said units and following a linear path through the rest of said units.
